(19) United States
(12) Patent Application Publication
(10) Pub. No.: US 2026/0253164 A1
(43) Pub. Date: Aug. 27, 2026

(54) GRAPHICS PROCESSING SYSTEMS

(71) Applicant: Arm Limited, Cambridge (GB)

(72) Inventor: FRANK KLAEBOE LANGTIND, Melhus (NO)

(73) Assignee: Arm Limited, Cambridge (GB)

(21) Appl. No.: 19/065,794

(22) Filed: Feb. 27, 2025

(51) Int. Cl. G06T 1/20; G06F 9/38

(52) U.S. Cl. CPC G06T 1/20; G06F 9/3836; G06F 9/3867

(57) ABSTRACT

A graphics processor is operable to execute a processing pipeline comprising a sequence of pipeline stages using one or more shared processing circuits. The execution of the processing pipeline is controlled by a pipeline manager that is operable to select respective sets of work for processing from respective work queues associated with the different pipeline stages, and to provide the selected sets of work to an iterator circuit that will then perform the desired processing. The iterator circuit is controlled to perform different processing for different pipeline stages.

### BACKGROUND

The technology described herein relates to graphics processing, and graphics processors, and in particular to the operation and configuration of a graphics processor to execute a processing pipeline.

Graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles.

Each primitive is usually defined by and represented as a set of vertices, where each vertex typically has associated with it a set of “attributes”, i.e. a set of data values for the vertex. These attributes will typically include position data and other, non-position data (varyings), e.g. defining colour, light, normal, texture coordinates, etc, for the vertex in question.

For a given output, e.g. frame to be displayed, to be generated by the graphics processing system, there will typically be a set of vertices defined for the output in question. The primitives to be processed for the output will then be indicated as comprising given vertices in the set of vertices for the graphics processing output being generated. Typically, the overall output, e.g. frame to be generated, will be divided into smaller units of processing, referred to as “draw calls”. Each draw call will have a respective set of vertices defined for it and a set of primitives that use those vertices.

Once primitives and their vertices have been generated and defined, they can be processed by the graphics processing system, in order to generate the desired graphics processing output (render target), such as a frame for display. This basically involves rendering the primitives to generate the graphics processing output.

The rendering process uses the vertex attributes associated with the vertices of the primitives that are being processed. To facilitate this operation, the vertices defined for the given graphics processing output (e.g. draw call) are usually subjected to an initial so-called “vertex shading” operation, before the primitives are rendered.

The vertex shading operation typically produces (transformed) vertex positions and one or more outputs explicitly written by the vertex shader. (Attributes output from the vertex shader other than position are usually referred to as “varyings”.)

A graphics processing pipeline will typically therefore include one or more vertex shading stages (vertex shader(s)) that execute vertex shading operations, e.g. using the initial vertex attribute values defined for the vertices (and otherwise), so as to generate a desired set of output vertex attributes (i.e. appropriately “shaded” attributes) for use in subsequent pipeline stages of the graphics processing pipeline.

Once the vertex attributes have been shaded, the “shaded” attributes are then used when processing the vertices (and the primitives to which they relate) in the remainder of the graphics processing pipeline.

For example, the “vertex shaded” vertex positions and varyings may be used when rendering the primitives to provide the render output, for example when performing rasterization and/or fragment shading operations. In the case of a tile-based graphics processing pipeline (where the two-dimensional render output (target) is rendered as a plurality of smaller area sub-regions, usually referred to as “tiles”), the vertex shaded (transformed) positions may be used to sort the primitives relative to the rendering tiles and/or to derive data structures for allowing the primitives to be sorted relative to the rendering tiles.

A vertex shading operation in a graphics processing pipeline will, accordingly, process one or more and typically a plurality of vertices (which can correspondingly be considered to be respective “work items” for the shading operation), to produce a respective “vertex shaded” attribute or attributes for each vertex (work item) that is processed (which attribute or attributes can correspondingly be considered to be respective data elements for the vertex (work item) in question).

Graphics processing pipelines can also include various other (shading) stages that process respective work items and generate a respective data element or elements for each of the work items that they process.

For example, in more advanced geometry processing flows, e.g., where tessellation is enabled, the vertex shading stages described above may be followed by one or more tessellation stages, which tessellation stages typically include a tessellation control shader (TCS) stage (e.g. that determines an amount of tessellation to perform), a tessellation stage that performs the desired tessellation operations (e.g. by executing a tessellation shader and/or using a (fixed-function) tessellation hardware circuit), and a tessellation evaluation shader (TES) (that applies interpolation or other post-processing operations on the tessellated output). More advanced graphics processing flows may also include other stages that perform vertex post-processing such as, but not limited to, a transform feedback stage that captures primitives generated by the vertex processing.

As another example, rather than performing vertex processing (shading) in the manner described above, a graphics processing pipeline may be configured to implement so-called “task” and “mesh” shading stages (shaders). Compared to traditional vertex shading operations, wherein a vertex shader may simply load in a certain number of vertices and then process (i.e. shade) them, a mesh shading stage (mesh shader) is operable to create its own output vertices and primitives.

For instance, a task shading stage (task shader) (also sometimes referred to as an “amplification” shader) can be executed to determine how many child mesh shader workgroups should be launched in a subsequent mesh shading stage (mesh shader). Each mesh shader workgroup can then produce a respective set of output vertices and primitives (i.e. a “meshlet”) with all mesh shader workgroups together creating the full output mesh (and so mesh shaders may perform “compute” shader-like processing in which mesh shader workgroups cooperatively generate meshes).

A task shader may also optionally output a payload that is passed to any of its child mesh shader workgroups.

The use of such “task” and “mesh” shaders can at least in some cases thus provide greater flexibility for the application programmer, e.g. compared to graphics processing pipelines that implement more traditional vertex shading operations, as the inputs to and outputs from the “task” and “mesh” shaders can be customised.

Thus, a graphics processor may execute a graphics processing pipeline to support a desired graphics processing flow, and the graphics processor (hardware) may accordingly be configured to support the particular graphics processing pipeline that is desired to be executed by the graphics processor. In this regard, it would be possible to execute any desired graphics processing pipeline in software, e.g. using general purpose compute shader operations. However, this is not normally efficient, and so some level of hardware support is often provided for the graphics processing pipeline, with the pipeline stages typically being specialised to perform certain processing operations for executing a particular graphics processing pipeline.

The Applicant believes, however, that there remains scope for improved arrangements in this regard when a graphics processor is to execute a processing pipeline.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows an example of a geometry packet pipeline that may be executed according to an embodiment;

FIG. 5 shows schematically an arrangement of processing circuitry for implementing such geometry packet pipeline according to an embodiment;

FIG. 6 shows in more detail an arrangement of processing circuitry for implementing a packet shading pipeline according to an embodiment;

FIG. 7 is a flow chart showing an initialisation process according to an embodiment;

FIG. 8 and FIG. 9 show two examples of how a shared packet queue may be partitioned into respective per-pipeline stage packet queues according to an embodiment;

FIG. 10 shows schematically an arrangement of state/configuration storage that may be used according to an embodiment;

FIG. 11 is a flow chart showing the operation of the pipeline manager according to an embodiment;

FIG. 12 shows schematically packet iterator state that may be used according to an embodiment;

FIG. 13 is a flow chart showing the operation of the packet iterator according to an embodiment; and

FIG. 14 and FIG. 15 are flow charts illustrating memory allocation and deallocation operations according to an embodiment.

### DETAILED DESCRIPTION

A first embodiment of the technology described herein comprises a graphics processor operable to execute a processing pipeline comprising a logical sequence of pipeline stages, the graphics processor comprising:
one or more processing circuits to execute the logical sequence of pipeline stages, the one or more processing circuits including:
an iterator circuit to process sets of work;
a set of work queues, wherein respective work queues within the set of work queues correspond to and identify respective sets of work to be processed for different, respective pipeline stages within the logical sequence of pipeline stages to be executed as part of the processing pipeline; and
a pipeline manager, the pipeline manager operable to provide respective sets of work from the work queues to the iterator circuit for processing,
wherein the pipeline manager is operable to provide the iterator circuit with sets of work from any of the work queues within the set of work queues (and hence to provide the iterator circuit with sets of work for any of the corresponding pipeline stages to be executed as part of the processing pipeline), and
wherein when a respective set of work to be processed for a particular pipeline stage is provided to the iterator circuit for processing, the iterator circuit controls processing of the set of work according to a respective processing operation to be performed for that particular pipeline stage.

A second embodiment of the technology described herein comprises a method of operating a graphics processor to execute a processing pipeline comprising a logical sequence of pipeline stages, the graphics processor comprising:
one or more processing circuits to execute the logical sequence of pipeline stages, the one or more processing circuits including:
an iterator circuit to process sets of work;
a set of work queues, wherein respective work queues within the set of work queues correspond to and identify respective sets of work to be processed for different, respective pipeline stages within the logical sequence of pipeline stages to be executed as part of the processing pipeline; and
a pipeline manager, the pipeline manager operable to provide respective sets of work from the set of work queues to the iterator circuit for processing,
wherein the pipeline manager is operable to provide the iterator circuit with sets of work from any of the work queues within the set of work queues (and hence to provide the iterator circuit with sets of work for any of the corresponding pipeline stages to be executed as part of the processing pipeline), and
the method comprising:
the pipeline manager providing a respective set of work from the respective work queue corresponding to a particular pipeline stage to the iterator circuit for processing; and
the iterator circuit controlling processing of the set of work according to a respective processing operation to be performed for that particular pipeline stage.

The technology described herein relates to graphics processors that are operable to execute processing pipelines that may comprise a certain logical sequence of pipeline stages to process respective sets of work to produce a desired output.

In embodiments, the processing pipeline that is executed is operable to process “packets” of work items.

In this respect, a “packet” may generally comprise any suitable and desired collection of work items to be processed, and which work items may, e.g., depending on the pipeline stage in question and the processing to be performed for that packet, comprise any suitable and desired set of work items. A “packet” may thus contain a set of (similar) work items that should be processed by a single task.

For example, in the context of geometry processing, the work items within a packet may comprise any of vertices, meshes, tasks, bounding boxes, primitives, etc., for which processing is to be performed.

In general, however, the packets that are processed by the processing pipeline may contain any suitable and desired data that may be produced by one pipeline stage and then consumed by a later pipeline stage, and various arrangements would be possible in this regard.

For instance, in the case of a task (or amplification) shader, the task shader may produce packets of data to be used by a subsequent mesh shader stage, but this data may generally have any suitable format (and it is a benefit of using such task shaders therefore that any suitable and desired data may be produced and passed to the mesh shader stage for further processing, and so the use of task/mesh shaders may provide the application programmer with increased flexibility as to the processing that is performed by the processing pipeline).

Thus, each pipeline stage may be, and in embodiments is, operable and configured to generate data elements for a set of work items (such as vertex attributes for vertices in the case of a vertex shading stage, etc.), and the pipeline stages are operable to process such sets of work items at a “packet” granularity.

Accordingly, the entities that pass through the logical sequence of pipeline stages of the graphics processing pipeline, and for which processing is performed within the pipeline stages of the graphics processing pipeline, in embodiments comprise respective “packets” comprising (data for) typically plural of the work items (e.g. vertices, etc.) that the respective pipeline stages are generating data for.

As will be explained further below, the processing pipeline that is executed in the technology described herein may also be operable to process other items of work, such as commands to update state and/or to trigger processing work.

The processing pipeline will thus comprise a certain logical sequence of pipeline stages, with any packets (and/or commands, etc.) produced/output from one pipeline stage in embodiments then being passed as input to a next pipeline stage, and so on, to execute the logical sequence of pipeline stages that are to be executed as part of the overall processing pipeline.

According to the technology described herein, however, rather than each pipeline stage being supported by its own dedicated processing circuit, with these circuits being connected in a pipelined manner to map to the processing pipeline that is being executed, the logical sequence of pipeline stages is executed using a set of processing circuits that is in effect shared between multiple (e.g. all) of the different pipeline stages within the logical sequence of pipeline stages to be executed as part of the processing pipeline.

Thus, any, and in embodiments each, of the pipeline stages within the logical sequence of pipeline stages to be executed as part of the processing pipeline can be executed using the same underlying processing circuits (e.g. hardware).

This then means that the processing pipeline may generally contain different logical sequences of pipeline stages, including different numbers of pipeline stages, and this can be adaptively supported by the same underlying (shared) processing circuits. For example, and in embodiments, the number of pipeline stages executed as part of the processing pipeline can be configured and re-configured in use.

That is, rather than providing a static arrangement of standalone processing circuits, wherein each respective processing circuit is operable and configured to execute a respective, single pipeline stage, the processing pipeline in the technology described herein can include a certain sequence of pipeline stages in which each pipeline stage within the sequence of pipeline stages can be, and in embodiments is, executed using the same underlying (shared) processing circuits. This can then provide various benefits.

For instance, in the technology described herein, the use of the (shared) processing circuits to execute the processing pipeline means that the graphics processor is able to more flexibly accommodate different numbers of pipeline stages within the processing pipeline. This may therefore provide more efficient use of silicon (area), and/or allow more complex processing pipelines (e.g. having larger numbers of pipeline stages) to be supported, e.g., and in embodiments, without having to provide additional dedicated circuits to do so.

This can also improve overall graphics processor performance. In particular, depending on the number of pipeline stages that are to be executed as part of a particular instance of processing pipeline execution, appropriate and different amounts of the processing resource provided by the set of shared processing circuits that is used to execute the sequence of pipeline stages can be made available for those pipeline stages.

Thus, if there are relatively fewer pipeline stages to be executed as part of the processing pipeline, these pipeline stages may then be provided with relatively increased use of such shared processing resource. The approach according to the technology described herein can therefore provide potentially improved performance, at least in certain situations, e.g. compared to more static arrangements where the amount of processing resource available to each pipeline stage may be essentially fixed. Further, in such static arrangements, if there are fewer pipeline stages required for a particular processing pipeline than there are available processing circuits, some of the processing circuits may simply be disabled/not used, which may not be an efficient use of silicon (area).

Conversely, if there are a relatively greater number of pipeline stages to be executed as part of the processing pipeline, the approach according to the technology described herein can more flexibly accommodate this by simply allocating appropriate use of the processing resource provided by the set of shared processing circuits that is used to execute the sequence of pipeline stages to the different pipeline stages.

For instance, whilst a static arrangement of standalone processing circuits may in some instances help achieve higher throughput (e.g. since different pipeline stages can be executed in parallel), the number of processing circuits will place a strict upper limit on how many pipeline stages can be executed as part of the processing pipeline, and it may therefore be costly (in terms of silicon area) to support additional pipeline stages.

Thus, the approach according to the technology described herein can provide an overall improved, e.g. more flexible, approach for implementing a logical sequence of pipeline stages that is to be executed as part of a processing pipeline, that in embodiments provides a more efficient use of the available silicon (area).

As mentioned above, the logical sequence of pipeline stages is executed using a set of processing circuits that is shared between the different pipeline stages within the logical sequence of pipeline stages to be executed as part of the processing pipeline. The processing resource provided by the set of processing circuits can therefore be, and in embodiments is, shared between multiple, different pipeline stages in use.

For instance, in this regard, some of the processing resource provided by the set of shared processing circuits that is used to execute the sequence of pipeline stages will be effectively shared on a time-division basis, i.e. so that certain processing logic is operable to perform processing for any particular pipeline stage within the logical sequence of pipeline stages to be executed as part of the processing pipeline, but may only be able to perform that processing for one particular pipeline stage at a time. It will be appreciated that the approach according to the technology described herein may therefore have reduced throughput, since in embodiments there will effectively only be one pipeline stage that is executed by the (shared) processing circuits at any instant in time.

The Applicant has recognised however that in practice the throughput of work (e.g. packets) between pipeline stages is often not a rate limiting factor for typical graphics processor applications. Therefore, at least for typical graphics processor applications, any possible performance impact may be relatively limited.

Similarly, there may be other shared resource (such as a shared work ‘buffer’, as will be discussed further below) that will be effectively partitioned between the different pipeline stages, based on the number of pipeline stages that are to be executed as part of the processing pipeline. Thus, if there is a relatively greater number of pipeline stages are to be executed, each of those pipeline stage may have access to a relatively smaller proportion of such shared resource, but again, any possible performance impact may be relatively limited, and/or may only apply when there are greater numbers of pipeline stages.

Conversely, if relatively fewer pipeline stages are to be executed, each pipeline stage can be provided with greater amounts of such shared resource, thus potentially increasing overall graphics processor performance (e.g. at least compared to more static arrangements where the amount of a corresponding resource available to each pipeline stage may be fixed, independently of the number of pipeline stages that are to be executed).

The technology described herein may therefore provide various benefits compared to other possible approaches.

Subject to the particular requirements of the technology described herein, the set of shared processing circuits that executes the logical sequence of pipeline stages may comprise any suitable and desired set of shared processing circuits.

In particular, according to the technology described herein, the graphics processor comprises one or more processing circuits to execute the sequence of pipeline stages that include (at least):
an iterator circuit to process certain sets of work (for (and to execute) the pipeline stages of the processing pipeline);
a set of work queues for storing respective sets of work (e.g. packets) to be processed for the different pipeline stages within the sequence of pipeline stages (and which work queues can optionally also store other items, e.g. commands to update state, to be processed by the processing pipeline); and
a pipeline manager that is operable to provide sets of work from the respective work queues to the iterator circuit for processing, and to manage the overall execution of the sequence of pipeline stages.

In the technology described herein, there will therefore be an iterator circuit (which may also be referred to herein as a “packet iterator”) that performs the required processing to execute the different pipeline stages that are to be executed.

In some embodiments, there is a single iterator circuit that is shared between, and executes, all of the different pipeline stages within the processing pipeline, and a single pipeline manager.

It would also be possible for there to be more than one iterator circuit, with either a single pipeline manager operable to provide sets of work (e.g. packets) to the different iterator circuits, as appropriate, or with separate pipeline managers being provided for each iterator circuit. This may then allow some degree of parallelisation or overlap between pipeline stages.

In general, however, the number of pipeline stages that can potentially be executed will be greater than the number of iterator circuits, such that the iterator circuit will typically have to (and is therefore operable and configured to) support the execution of multiple, different pipeline stages.

In this respect, it will be appreciated that a given pipeline stage within the processing pipeline may generally produce for an incoming set of work (which incoming set of work may, e.g. correspond to an incoming “packet” of work items that has produced by a previous pipeline stage, but in the case of a task shader, for instance, could also correspond to a set of work that is to be triggered by an initial command to perform that work, and various arrangements would be possible in this regard), a corresponding set of zero or more (child) output packets.

The output packets from a given pipeline stage will in turn be passed to a next processing stage, e.g. a next pipeline stage, or output unit, within the processing pipeline for further processing.

A given pipeline stage may therefore generally receive as input a stream of incoming packets (or commands, etc., as the case may be), and in turn may correspondingly produce a stream of output packets, e.g. that are to be passed as input to a next processing stage of the processing pipeline. The processing within a current pipeline stage may thus generate the (data for) the output packets that will be produced by that pipeline stage. A next processing stage may accordingly receive the output packets and determine which (if any) further processing is to be performed for those packets.

To track this, in the technology described herein, a set of work queues is provided that is used to identify the sets of work (e.g. packets) that are to be processed for the different pipeline stages. For instance, each pipeline stage may, and in embodiments does, have its own respective work queue which is operable to store a list of identifiers for the respective sets of work (e.g. packets) that are to be processed for that pipeline stage. As alluded to above, the work queues may also be operable to store other items, such as commands to update pipeline configuration/state, and/or commands defining a new processing job or task that is to be performed.

The pipeline manager that manages the overall execution of the sequence of pipeline stages is thus operable to select a next item to be processed from any of the work queues within the set of work queues, and at least when the next item is a packet, or a command defining a new processing job or task that is to be performed (e.g. in the case of a task shader), to then provide the selected item to the iterator circuit for processing.

This selection of the next item to be processed can be done in any suitable and desired manner, e.g. using any suitable arbitration scheme between the work queues, but so long as there are available and valid items, i.e. that are ready to be processed, within the work queues, the pipeline manager may generally select a next item (e.g. packet, command, etc.) for processing from any of the work queues within the set of work queues.

Accordingly, when an item is selected for processing, the processing that will be performed will depend on the item that is selected.

At least in the case when the next item is a packet or command that is to be provided to the iterator circuit for processing, the processing that is performed for the set of work defined by that packet/command will also depend on which work queue the item was selected/provided from, i.e. for which pipeline stage the set of work is to be processed for (and hence which pipeline stage is to be executed by the iterator circuit).

It will be appreciated that the iterator circuit should be, and is, therefore, operable to perform processing for sets of work for multiple, different (e.g. each and any) of the pipeline stages within the sequence of pipeline stages that is being supported by the set of shared processing circuits.

That is, in order to execute the sequence of pipeline stages, the (same) iterator circuit will process sets of work for a first pipeline stage but will in embodiments also process sets of work for second or further pipeline stages within the sequence of pipeline stages, with the iterator circuit effectively being shared, on a time-division basis, between the different pipeline stages.

The iterator circuit will thus need to be appropriately controlled to perform the relevant processing operations, depending on which pipeline stage is to be executed for the next instance of processing.

The iterator circuit thus comprises appropriate logic to control its processing of sets of work according to the particular processing operations to be performed for the different pipeline stages within the sequence of pipeline stages.

However, the processing steps (and logic) performed by the iterator circuit are in embodiments ‘generic’, so that the same basic processing steps are performed by the iterator circuit for any and all sets of work that may be processed by the iterator circuit, independently of which pipeline stage is being executed, but these same basic processing steps will trigger different processing of depending on which particular pipeline stage is being executed by the iterator circuit.

To control this, in embodiments, the graphics processor stores a set of pipeline configuration information that defines the current configuration of the sequence of pipeline stages within the overall processing pipeline, and in particular defines the number and types of pipeline stages that are to be executed. The set of pipeline configuration information may also store any other suitable configuration information that may desirably be used to control the execution of the processing pipeline, and this may include both configuration information relating to the processing pipeline as a whole, and configuration information relating to the individual pipeline stages within the processing pipeline.

Thus, when a set of work (e.g. a packet) is provided to the iterator circuit for processing for a particular pipeline stage, the processing that is performed by the iterator circuit is determined and controlled based on the pipeline configuration information that applies to the particular pipeline stage in question. The relevant pipeline configuration information should can thus be, and in embodiments is, provided to the iterator circuit along with the set of work that is to be processed to control this.

Thus, in embodiments, there is stored for a particular instance of processing pipeline execution, a set of pipeline configuration information defining the number and type of pipeline stages to be executed as part of the processing pipeline, and wherein the iterator circuit uses the stored pipeline configuration information to control its processing of sets of work to execute the pipeline stages within the sequence of pipeline stages to be executed as part of the processing pipeline.

In this way, the iterator circuit can be, and is, caused to control the processing of a set of work for a particular pipeline stage according to the respective processing operations that are to be performed for that particular pipeline stage.

For example, a given pipeline stage may receive an incoming set of work (e.g. a packet) to be processed, and will then perform appropriate processing for the incoming set of work, depending on the pipeline stage in question.

In general, this processing will involve determining a corresponding one or more (child) output packets to be produced by, and processed within, the pipeline stage. In this respect, it will be appreciated that the number of (child) output packets that will be produced in respect of an incoming set of work may be relatively larger, and that a given pipeline stage may therefore “amplify” the number of packets propagating within the processing pipeline.

For a (and each) (child) output packet to be produced/processed, the pipeline stage may then create a respective packet identifier identifying the (child) output packet, which packet identifier may then be provided for output, e.g., to pass the packet to a next processing stage (which next processing stage may, e.g., be a next pipeline stage in the sequence of pipeline stages, or could be a final processing stage that drains (primitive) packets from the processing pipeline). For instance, when the packet is provided to a next pipeline stage (i.e. the current pipeline stage is not the last pipeline stage), the packet identifier may then be added to the end of the work queue for the next pipeline stage.

The pipeline stage will also generate data for the (child) output packet(s) that it produces. In this respect, for each output packet to be produced/processed, the pipeline stage may be operable and configured to first allocate a respective portion of memory for storing (data for) the packet.

Once the memory has been allocated, the pipeline stage may further be operable and configured to trigger execution of a desired shader program for producing the data for the (child) output packet in question, which data will then be written to the allocated portion of memory.

A given pipeline stage may also be operable to trigger deallocation of memory that has previously been allocated (by a previous pipeline stage). For example, once a packet produced by one pipeline stage has been consumed, the data for that packet can be invalidated, and the portion of memory that was allocated for storing that data freed so that it is available to be allocated for new packets that are to be produced/processed.

The iterator circuit should therefore be, and in embodiments is, operable to support any and all of these processing operations.

For instance, various arrangements would be possible as to which processing operations will be performed when executing a particular pipeline stage, and in general the iterator circuit should therefore be able to support any and all of these processing operations in order to execute the different types of pipeline stages that may be supported by the processing pipeline in the technology described herein.

Further, as mentioned above, the iterator circuit should be generic, so that the different pipeline stages can all be supported by the same underlying processing circuits (logic) performing the same basic processing steps.

Thus, when executing a given pipeline stage, the iterator circuit is in embodiments operable and configured to perform some or all of the following (generic) processing steps in respect of an incoming set of work (e.g. a packet) that is to be processed by the pipeline stage in question:
determining a corresponding output (child) packet to be produced by the pipeline stage;
allocating a portion of memory for storing an output (child) packet to be produced by the pipeline stage;
creating a packet identifier for an output (child) packet to be produced by the pipeline stage and providing the packet identifier for output to a next processing stage (which may, e.g., be a next pipeline stage within the processing pipeline, or may be a final processing stage that drains (primitive) packets from the processing pipeline);
issuing a shading request to trigger execution of a respective shader program (e.g. a compute shader) to be executed to produce data for a corresponding output (child) packet; and
deallocating a portion of memory that has previously been allocated for storing a packet for which the current pipeline stage is the last pipeline stage that will use the packet (i.e. where the packet is consumed by the current pipeline stage).

In embodiments, therefore, the iterator circuit is at least operable to perform any or all of these basic processing steps. The iterator circuit may of course also be operable to perform any other suitable processing steps that may desirably be performed to execute the pipeline stages.

Which of these processing steps is actually performed for a given instance of pipeline stage execution, i.e. in respect of a given incoming set of work (e.g. packet), may, however, depend on the particular pipeline stage that is being executed.

In embodiments, therefore, as mentioned above, in order to allow the iterator circuit to execute the different pipeline stages, a set of pipeline configuration/‘state’ information that defines the particular processing operations to be performed to execute the various different pipeline stages is provided, and stored by the graphics processor, so that when the iterator circuit is to execute a particular pipeline stage, the relevant pipeline configuration information that applies for that particular pipeline stage is also provided to the iterator circuit together with the packet(s) to be processed.

This pipeline configuration information is then used by the iterator circuit to control the processing that is performed according to the particular processing operations to be performed for the pipeline stage being executed.

For example, the configuration information may specify a shader program that is to be invoked in respect of a particular pipeline stage, as well as optionally a work group size, whether memory allocations/deallocations are to be performed, etc., which information will then be used by the iterator circuit to perform the appropriate processing operations to execute the pipeline stage.

Various arrangements would be possible in this regard.

The effect and benefit of all of this is therefore to provide a more flexible approach for implementing such processing pipeline including a number of pipeline stages, in particular so that the same underlying processing circuits (e.g. hardware) can adaptively support different logical sequences of pipeline stages, including different numbers (and types) of pipeline stages.

This can provide a particularly (silicon) area efficient approach for supporting different processing pipelines, so that the graphics processor is able to support more advanced graphics processing flows (whilst still being able to support simpler graphics processing flows) using the same set of processing circuits.

For instance, in embodiments, the number of pipeline stages that are executed as part of the processing pipeline is configurable, and re-configurable, in use, and the set of processing circuits is controlled accordingly based on the particular sequence of pipeline stages to be executed.

This can also therefore increase utilisation of the graphics processor as the set of processing can be adapted appropriately to the particular sequence of pipeline stages to be executed. Thus, if relatively fewer pipeline stages are to be executed, they can be provided with greater use of the processing circuits.

Subject to the particular requirements of the technology described herein, the graphics processor may be operable and configured in any suitable and desired manner.

For example, as mentioned above, the graphics processor comprises a set of work queues, wherein respective work queues within the set of work queues correspond to and identify sets of work to be processed for different, respective pipeline stages within the logical sequence of pipeline stages to be executed as part of the processing pipeline.

Thus, each pipeline stage that is to be executed will in embodiments have its own respective work queue that identifies the sets of work, e.g. “packets” that are to be processed for that pipeline stage. The work queues may optionally also store other items, e.g. commands to update state, and/or trigger processing work, that may need to be processed for the pipeline stages.

The work queues for the different pipeline stages may generally be arranged and stored in any suitable and desired fashion.

In embodiments, however, the work queues correspond to respective partitions of a shared overall work ‘buffer’ that is available for use by the sequence of pipeline stages as a whole.

In particular, in embodiments, the graphics processor comprises, or has access to, appropriate storage in which such shared work buffer resides, and this shared work buffer is then partitioned, in use, into a set of work queues based on the number of pipeline stages to be executed so that each pipeline stage to be executed has its own partition/work queue.

In this respect it will be appreciated that in some instances the processing pipeline may only need to support a single pipeline stage, in which case there may only be a single work queue, and this is in embodiments handled in the same way described above (although in this case the pipeline manager operation may be simplified as there is then no need to arbitrate between multiple work queues).

The work buffer (and hence work queues) may generally reside in any suitable and desired stored that is accessible by the set of processing circuits that will execute the sequence of pipeline stages. For instance, in embodiments, the work buffer (and hence work queues) resides in storage that local to, and on chip with, the set of processing circuits that will execute the sequence of pipeline stages so that packets and other items can readily be provided from the work queues to the iterator circuit for processing.

In embodiments, the partitioning of the shared work buffer into the set of work queues is done as part of a configuration process for the processing pipeline. For instance, when a new processing job is received that will use the processing pipeline, before issuing any work to the processing pipeline, the processing pipeline may first be configured appropriately for the processing job in question.

In this regard, as mentioned above, a benefit of the technology described herein is that the graphics processor can support different processing pipelines having different numbers (and types) of pipeline stages.

Thus, the relevant pipeline configuration information for an incoming processing job, which pipeline configuration information will include the number of pipeline stages, etc., to be executed for the next instance of processing pipeline execution can be provided to the pipeline manager, and then used thereby to define/initialise the relevant pipeline configuration information for the next instance of processing pipeline execution. As part of this configuration process, the work buffer (and any other shared storage) is in embodiments partitioned accordingly based on the number of pipeline stages that are to be executed for the next instance of processing pipeline execution.

The partitioning of the shared work buffer into the set of work queues can be done in any suitable and desired manner, e.g. depending on how many, and which, pipeline stages are to be executed. For example, if the processing pipeline is configured to include a sequence of four pipeline stages, the work buffer is in embodiments then partitioned into four, in embodiments equal-sized, work queues, one for each pipeline stage. Thus, in embodiments, the partitions/work queues have equal sizes, so that each partition/work queue can store the same number of items. However, this is not necessary, and in some cases, the partitions/work queues may have different sizes, if appropriate/desired.

Various arrangements would be possible in this respect.

It will also be appreciated in this regard that the size of the work buffer may therefore place an effective upper limit on the number of pipeline stages that can be supported. In particular, in embodiments, to ensure progress can be made throughout the processing pipeline, the partition/work queue for each pipeline stage should contain at least one entry.

In that case, the number of entries within the work buffer may accordingly limit the number of pipeline stages that can be implemented. However, it will be appreciated that a single entry in a work queue (i.e. for identifying a single packet, command, etc.) will not require much storage space, and so in practice the shared work buffer may contain a relatively larger number of entries, and hence the graphics processor in the technology described herein can correspondingly support a relatively larger number of pipeline stages, without adding significant silicon area cost.

For example, in embodiments, the shared work buffer may contain N or more entries, and so the processing pipeline may correspondingly include up to N different pipeline stages that all be supported by the same processing circuits (i.e. rather than requiring N standalone processing circuits to support this). In this respect, the number of entries, N, within the shared work buffer could for example be 16, 32, 64, etc., so that the approach according to the technology described herein can readily scale to larger processing pipelines.

Thus, in embodiments, there is a shared work buffer that is partitioned, in use, into a set of work queues based on the number of pipeline stages to be executed.

As mentioned above, the configuring of the shared work buffer into the respective partitions/work queues is in embodiments performed by the pipeline manager and this configuring/re-configuring may be done between any suitable instances of processing pipeline execution (such as between render passes, or even between draw calls within a render pass).

Various arrangements would be possible in this regard.

It will also be appreciated that re-configuring the partitions within the shared work buffer may have a certain cost, e.g. in terms of latency. In some instances, re-configuring the partitions within the shared work buffer may even require draining the processing pipeline of work. Therefore, in some situations it may be desirable to not re-configure the partitions within the shared work buffer, even though the number of pipeline stages has changed. This is generally acceptable, e.g., and in particular, so long as the number of pipeline stages has not increased, as each pipeline stage will still have a respective work queue (there will just be some entries within the work buffer that are not used).

Thus, in embodiments, the pipeline manager is operable to selectively determine whether or not to re-configure the partitions within the shared work buffer into work queues (and to not do this at least in some situations).

Various suitable metrics may be used in this regard to determine whether or not the work buffer should be re-partitioned.

As discussed above, the processing pipeline in the technology described herein is in embodiments configurable.

In embodiments, therefore, the configuration of the processing pipeline, including the number and type of pipeline stages to be executed, can be re-configured over time so that the number and type of pipeline stages to be executed may change between instances of processing pipeline execution.

This means that the pipeline configuration information that is used by the iterator circuit to control the processing of sets of work (e.g. packets) may also need to be updated over time to reflect the new pipeline configuration.

In embodiments, this is done by sending suitable state update commands through the processing pipeline. The state update commands may therefore be propagated through the processing pipeline in a similar way to the packets that are described above, such that a state update command will be processed by each of the pipeline stages in turn.

This can be, and in embodiments is, managed using the work queues, such that the work queues are operable to not only store identifiers of respective sets of work (e.g. packets, etc.) to be processed but to also store state update commands.

As mentioned above, the pipeline manager is generally operable to select a next item to be processed from any of the available work queues, and this selection is in embodiments done in the same manner for state update commands as it is done for packets, or other items, that may be stored in the work queues. Thus, the next item that is selected to be processed by the pipeline manager could be a state update command. When a state update command is selected as the next item to be processed, this is then processed accordingly to update the relevant pipeline configuration information.

The processing of the state update command to update the pipeline configuration information could be performed in any suitable manner but in embodiments this is performed and managed by the pipeline manager, e.g., and in embodiments, without the pipeline manager providing the state update command to the iterator circuit. Thus, when the pipeline manager selects a state update command from one of the work queues, the pipeline manager in embodiments then processes the state update command by updating the relevant pipeline configuration information, as appropriate.

In embodiments, this updating is performed incrementally so that the particular pipeline configuration information that applies to a given pipeline stage is updated as and when the state update command is processed by that pipeline stage.

Thus, as the state update commands propagate through the processing pipeline, the relevant pipeline configuration information will be updated accordingly so that once the state update command has been processed by a given pipeline stage, the relevant pipeline configuration information that applies to that particular pipeline stage will be updated. This then means that once the state update command has been processed in respect of a given pipeline stage, the next item in the work queue for that pipeline stage can be processed immediately (without having to wait for the state update command to reach the end of the processing pipeline). This can therefore avoid having to always drain the pipeline whenever there is any configuration change.

Once the pipeline manager has processed a state update command for a given pipeline stage, and updated any relevant pipeline configuration information, as appropriate, the pipeline manager should accordingly add the state update command into the work queue for the next pipeline stage, so that the state update command can be processed for the next pipeline stage, and so on.

Thus, in embodiments, state update commands to update the set of pipeline configuration information are propagated through the processing pipeline, and the set of work queues is thus also operable to store state update commands (alongside any packets/other commands to be processed). The pipeline manager is thereby operable when selecting a next item to be processed from the set of work queues to select either a state update command or a packet/other command, and at least when a state update command is selected, to then process the state update command to update some or all of the set of pipeline configuration information.

Once the state update command has passed all the way through the processing pipeline, being processed by each of the pipeline stages, as needed, it can optionally then be processed by a post-pipeline unit to update any global state for the processing pipeline.

In this way, the graphics processor can therefore, and does, maintain an up to date set of pipeline configuration information that can accordingly be used to control the processing circuits to execute the desired pipeline stages for the current configuration of the processing pipeline.

As mentioned above, therefore, a graphics processor according to embodiments of the technology described herein will comprise, or at least have access to, suitable storage that stores the pipeline configuration information needed to execute the sequence of pipeline stages within the processing pipeline.

The state update commands will therefore update the pipeline configuration information within this storage.

This storage is in embodiments arranged to store both global configuration/state information that is common to all pipeline stages (i.e. that applies to the processing pipeline as a whole) as well as any configuration/state information that applies (only) to respective individual pipeline stages.

When a set of work (e.g. a packet) that is to be processed for a given pipeline stage is provided to the iterator circuit for processing, the relevant pipeline configuration information for that pipeline stage may thus also be provided to the iterator circuit, to allow the iterator circuit to perform the desired processing operations.

For example, when the pipeline manager provides a set of work (e.g. a packet) to the iterator circuit for processing, the pipeline manager may also provide the iterator circuit with the relevant pipeline configuration information for controlling that processing. Alternatively, the iterator circuit may fetch the relevant pipeline configuration information itself, as part of its processing of the set of work. Various arrangements would be possible in this regard.

The data flow through the processing pipeline is thus managed using the work queues, in particular by including respective identifiers for the items to be processed into the respective work queues for the different pipeline stages, and the pipeline manager then selecting items from these work queues for processing.

In embodiments, to enforce ordering requirements within the processing pipeline, the pipeline manager when selecting items from the work queues is operable to always select items from the heads of the work queues (and correspondingly when items are provided for output from a given pipeline stage to a next pipeline stage, these items will be added to the tail of the work queue for the next pipeline stage). This then means that the items in the work queues in embodiments will remain in strict order as they propagate through the processing pipeline, which in turn means there may be no need to explicitly track the order of items within the processing pipeline. Thus, in embodiments, the work queues operate in a ‘first-in-first-out’ (FIFO) manner to enforce a desired ordering between pipeline stages.

Other arrangements would however be possible.

Thus, if the next item that is selected for processing by the pipeline manager is a state update command, this is processed by the pipeline manager, the relevant pipeline configuration information is updated, as needed, and the state update command is then added to the work queue for the next pipeline stage in the sequence of pipeline stages (if there is one).

On the other hand, if the next item that is selected for processing by the pipeline manager is a packet, or other set of work, that is to be provided to the iterator circuit for processing, this is done, as discussed above. The iterator circuit may thus process the incoming set of work, and produce a corresponding zero or more (child) output packets (although as will be described below, in embodiments, this is done over multiple processing cycles/iterations of the same set of work). These output packets may then be added to the work queue for the next pipeline stage in the sequence of pipeline stages (if there is one).

In this respect, it will be appreciated that a given pipeline stage may need to produce a larger number of output packets from an incoming set of work.

For example, the number of output packets to be produced could be pre-defined for a particular (type) of pipeline stage (e.g. as part of the pipeline configuration information), so that any incoming sets of work to that pipeline stage will produce a certain number of output packets.

Alternatively, the number of output packets to be produced could be determined by the processing pipeline, and therefore defined for individual packets. For example, in some cases, the number of output packets to be produced from an incoming packet will be defined by the previous pipeline stage that produced the incoming packet. This may be the case for a mesh shader, for instance, where the job size for the mesh shader may be determined by a prior task shader. For example, a job size may be defined for the pipeline stage handling the task shader. This means that the task shader does not receive incoming packets of work items, as such, but rather packets of ‘tasks’, and will generate packets according to the defined job size for the draw call. Whereas, the mesh shader will not have a job size defined for the draw call but will instead receive a job size from the incoming packets produced by the task shader.

In that case, the number of output packets may be specified within appropriate metadata associated with the packet, which metadata may be, and in embodiments is, stored in association with the packets (in memory). Thus, when such a packet is provided to the iterator circuit for processing, the associated metadata for that packet will be read in to determine the number of output packets that are to be produced (and this can then be stored locally to the processing circuits that will execute the processing pipeline, e.g. as part of the iteration state, as will be explained further below). Alternatively, some or all of this information could be stored within the work queues, e.g. as part of the identifier for that packet.

Various arrangements would be possible in this regard.

Thus, in general, a given pipeline stage may produce, for a single incoming set of work (e.g. a packet), multiple different output packets, and this may depend on the pipeline stage in question, and/or the set of work that is being processed.

Further, because the iterator circuit is operable to generically process packets for different pipeline stages, it may not be known in advance of a particular instance of iterator processing how much memory will be needed for all of the output packets that may need to be produced (as this will depend on the pipeline stage, and/or the set of work (packet), in question).

In view of this, in embodiments, the iterator circuit is therefore configured to (only) produce one output packet at a time (per processing cycle).

Thus, when the pipeline manager selects a set of work to be processed by the iterator circuit, the iterator circuit when processing that set of work is configured to only produce a single output packet (per processing cycle).

Accordingly, when multiple output packets are to be produced from an incoming set of work, that same set of work should be, and in embodiments therefore is, provided by the pipeline manager to the iterator circuit a corresponding multiple number of times, in order to produce the desired number of output packets.

That is, rather than the pipeline manager sending the packet to the iterator circuit once, and the iterator circuit then iterating over that packet multiple times in succession to produce all of the required output packets, in embodiments, the same packet will be provided by the pipeline manager to the iterator circuit, and processed thereby, multiple times until all of the iterations to produce the required number of output packets have completed. This also means that the iterations over a particular incoming set of work (e.g. a packet) need not be performed successively, as the pipeline manager may also select items from other work queues between iterations.

To manage this, therefore, it is in embodiments also tracked, for a (and each) set of work (e.g. packet) that is provided to the iterator circuit for processing, how many times that particular same set of work has been processed by the iterator circuit. This so-called ‘iteration’ state can therefore be updated by the iterator circuit each time the (same) set of work is processed and used by the pipeline manager to control how many times that set of work is provided to the iterator circuit for processing.

For instance, for a (and each) set of work (e.g. a packet), it can also be determined how many times the set of work should be processed, i.e. based on the pipeline stage, and/or the set of work, in question. The pipeline manager can thus use the ‘iteration’ state to determine whether and when the set of work has been processed the correct number of times. The iteration state therefore in embodiments tracks, for respective pipeline stages, the number of iterations that have been performed for the current set of work that is being processed by the respective pipeline stages. Accordingly, when a new set of work for a particular pipeline stage is issued to the iterator circuit for processing, once this processing has completed, the number of iterations for that set of work will be incremented by one, and the iteration state updated accordingly. So long as the number of iterations that have been performed is less than the number of iterations that should be performed for that set of work, the set of work will however remain in the work queue for the current pipeline stage, and so will eventually be selected again for processing. Only once the final iteration has been performed, i.e. such that the number of iterations that have been performed is equal to the number of iterations that should be performed, is the set of work removed from the work queue for the current pipeline stage.

Thus, in embodiments, the iterator circuit is operable and configured to produce one output packet per processing cycle. In that case, when a pipeline stage within the sequence of pipeline stages to be executed as part of the processing pipeline is to produce a plurality of output packets from a single incoming set of work (e.g. a single incoming packet), the pipeline manager may be operable and configured to provide the same set of work (packet) to the iterator circuit for processing a corresponding plurality of times to produce the plurality of output packets.

An incoming set of work to be processed by a particular pipeline stage will thus in embodiments remain in the respective work queue for that pipeline stage until the set of work has been processed enough times to produce all of the output packets that are to be produced from that same set of work, and to facilitate this the pipeline manager is in embodiments operable and configured to track how many times a same, single set of work has been processed by the iterator circuit in respect of a particular pipeline stage. The pipeline manager will thus cause the set of work to remain in its current work queue until the last iteration of that set of work has been performed, at which point the set of work can be removed from its current work queue.

In some cases, when a set of work (e.g. a packet) is provided to the iterator circuit for processing, the iterator circuit may not be able to perform the desired processing. A typical example of this would be when the memory allocation fails since there is not enough free memory that can be allocated for a corresponding output packet. In such cases, the iterator circuit may thus signal to the pipeline manager that the processing has failed, and this will cause the set of work to remain in the work queue for the current pipeline stage. The pipeline manager will accordingly, at some point, select that set of work for processing again, and provide the set of work to the iterator circuit again to re-try the processing.

It will be appreciated however that if a memory allocation has failed, the memory allocation will likely continue to fail until sufficient progress has been made elsewhere within the processing pipeline to cause some memory to be deallocated.

In embodiments, therefore, in the event that a memory allocation fails for a given set of work, the pipeline manager tries to avoid re-selecting that set of work until it is determined that there is free memory. To do this, in embodiments, in the event that a memory allocation fails for a set of work, the iterator circuit signals this to the pipeline manager, and a corresponding indication (e.g. a flag) associated with the set of work is set accordingly to indicate that the memory allocation has failed. This indication may, for example, be stored within the work queue in association with the entry for and identifying that set of work.

When this indication is set, the pipeline manager when selecting a next item to be processed, may then ignore that entry, and preferentially select a different item, i.e. from a different work queue, for processing.

Thus, in embodiments, the iterator circuit when executing a particular pipeline stage to process a set of work (e.g. a packet) is operable to allocate a portion of memory for storing a corresponding output packet that will be produced from the incoming set of work, and wherein when the memory allocation fails, the set of work remains in the respective work queue for the particular pipeline stage being executed so that the pipeline manager can subsequently re-select that set of work for processing.

Further, in response to a memory allocation for a set of work failing, a respective indicator associated with the set of work may be set accordingly to indicate that the memory allocation has failed, and the pipeline manager may then be controlled to not re-select that set of work for processing until the indicator has been reset to indicate that the processing should be re-tried.

For example, in embodiments, once the indicator (e.g. flag) has been set to indicate that the memory allocation has failed, the indicator may subsequently then be reset, or cleared, in response to a portion of the memory into which the memory allocation was requested being deallocated. That is, the indicator may be reset following a successful memory deallocation event that frees up a portion of the memory into which the allocation is to be performed. At that point, the set of work will therefore be available for selection, and at some point, will be selected again by the pipeline manager for processing, at which it point it will be provided again to the iterator circuit, and the memory allocation should now be successful (as there is now available memory that can be allocated).

In some embodiments the indicator may also be reset under other conditions, e.g. based on a time out condition, to allow the processing to be tried again even if no memory deallocation has been made. This may be appropriate to provide a failsafe operation. For instance, the memory allocation could have failed due to some transient error, rather than a lack of available memory, and so it may be desirable to try the processing again even without waiting for a successful memory deallocation event.

Various arrangements would be possible in this regard.

Thus, the arbitration scheme that is used by the pipeline manager to select which item is to be next processed may, and in embodiments does, consider such indication when making this selection. Otherwise, the arbitration scheme that is used by the pipeline manager to select which item is to be next processed may take any suitable form and may also consider any desired system conditions.

For example, in embodiments, this could involve a round-robin process where, so long as there is valid data available to be selected in the work queues, the pipeline manager selects items from the heads of each work queue in turn.

Other arrangements would however be possible and in general the arbitration scheme that is used by the pipeline manager to select which item is to be next processed may be more or less complex/‘intelligent’, as desired.

As discussed above, the technology described herein relates generally to graphics processors and graphics processor operation, and in particular to graphics processors that implement and support a (re-)configurable processing pipeline concept.

In particular, the processing pipeline can be, and is, implemented using a set of processing circuitry that is controlled to execute a certain logical sequence of pipeline stages, which pipeline stages map to a corresponding set of desired (different) stages of a (graphics) processing pipeline to be executed.

This configuration of the (number and type of) pipeline stages can thus be, and in embodiments is, performed in advance of, and for, a particular instance (or number of instances) of processing pipeline execution, e.g. prior to issuing any work to the processing pipeline for the particular instance(s) of graphics processing pipeline execution.

As discussed above, the processing pipeline, once configured, can then be executed accordingly to process “packets” of work items to generate an overall pipeline output.

The processing pipeline that can be (and is) executed by a graphics processor according to the technology described herein is thus in embodiments hardware-implemented (e.g. rather than being executed entirely in software, e.g. using general purpose computer shaders, which may be less efficient), but the processing pipeline (hardware) is in embodiments configured in software, and can therefore in embodiments also be re-configured in software, as desired, e.g. for different instances of processing pipeline execution (e.g. between render passes, or even within a render pass (e.g. between draw calls)).

This can then provide a more flexible and configurable approach as the processing pipeline can be configured and used to support various different graphics processing flows (including, for example, more advanced geometry processing flows, e.g. utilising task/mesh shaders, tessellation shaders, transform feedback, etc.) and this is in embodiments done using the same, underlying (generic) processing circuits (hardware) but with different processing being triggered (e.g., and in embodiments, including triggering different (shader) program execution) for the different pipeline stages depending on the particular configuration of the pipeline stages defining the graphics processing pipeline.

For example, a desired graphics processing flow can be suitably mapped onto a graphics processing pipeline, with a corresponding logical sequence of pipeline stages then being configured and programmed appropriately in advance of one or more instances of processing pipeline execution to support that graphics processing flow. The processing circuits can then be used to execute the desired logical sequence of pipeline stages, with this being done in an essentially generic manner, as discussed above, with the processing circuits processing packets of work items for different pipeline stages in a similar fashion, i.e. by performing the same, basic sequence of processing operations, but with different processing being performed in respect of different pipeline stages as part of those same, basic processing operations based on which pipeline stage is being executed (e.g., and in particular, by the iterator circuit invoking different shader programs depending on which pipeline stage is being executed).

For instance, a given pipeline stage may receive incoming packets of work items, or jobs, and then determine from this a corresponding set of zero or more packets that are to be further processed within the pipeline stage.

In this regard, it may often be the case, as discussed above, that the further processing that is to be performed within a pipeline stage in respect of a particular incoming (input) packet/job will output data elements that do not fit into a single (output) packet, in which case a corresponding plurality of “child” output packets may need to be, and in embodiments are, generated. Thus, at least some pipeline stages may generate multiple (child) output packets.

It could of course also be the case that an incoming packet/job does not need to be further processed within the pipeline stage.

Thus, the initial processing operations performed for a pipeline stage in embodiments determine (e.g. generate) from an incoming packet of work items a corresponding zero or more packets of work items to be further processed.

Depending on the result of these initial processing operations, the remaining packets (if any) will then be processed accordingly. This will depend on the configuration of the pipeline stage in question.

However, for at least some pipeline stages, this will involve allocation a respective portion of memory for (storing data for) the packets. In embodiments, this is done by the iterator circuit issuing a suitable memory allocation request to a respective memory manager (unit) that controls memory allocations/deallocations.

Once the memory manager (unit) has successfully allocated a respective portion of memory for a packet, this is accordingly signalled to the iterator circuit.

A given pipeline stage may generally perform any suitable and desired processing to produce the output packet. Typically, however, and in embodiments, a shader program should then be executed to process the packet to produce the desired output data. At least some of the pipeline stages that are executed by the iterator circuit are thus in embodiments “shader” stages, which are each operable to invoke execution of a respective shader program.

In this regard, the graphics processor will have a set of, typically plural, shader cores/execution engines that are operable to execute shader programs.

The graphics processor may include any suitable and desired arrangement of shader cores. Thus, the set of shader cores can be any suitable and desired set of shader cores that is operable to execute shader programs.

The set of shader cores may comprise a single shader core but in embodiments includes plural shader cores. Where there are plural shader cores, each shader core may be operable to execute shader programs in a similar manner. The (and each) shader core should, and in an embodiment does, comprise appropriate circuits (processing circuits/logic) for performing the operations required of the shader core. Where there are plural shader cores, each shader core may be provided as a separate circuit to other shader cores of the graphics processor, or the shader cores may share some or all of their circuits (circuit elements).

Various arrangements would be possible in this regard.

The iterator circuit thus in embodiments has a respective shading interface via which it can submit shading requests to the graphics processor's set of shader cores (with this shading interface also being ‘generic’ in that the iterator circuit can invoke different shader programs, as needed, depending on the pipeline stage being executed).

Such (generic) shading requests may, for example, be issued to a general purpose (e.g. “compute”) shader endpoint that is operable to trigger the shader program(s) specified for the different pipeline stages. Other arrangements would however be possible.

These shading requests will in embodiments also specify the respective shader program or shader programs that are to be executed for the pipeline stage that is currently being executed.

That is, when the iterator circuit issues a shader request to the graphics processor's set of shader cores, the shading request should therefore, and in embodiments does, also include an indication of which shader program (or programs) are to be executed. The shader program may be indicated relative to a preconfigured ‘shader binding table’, for example, that includes a list of available shader programs.

Various other arrangements would however be possible in this regard.

For instance, a pipeline stage that is configured as a vertex shading stage may trigger a vertex shader, whereas a pipeline stage configured as a mesh shading stage may trigger a mesh shader, etc.. However, the shader cores may generally perform any suitable and desired processing of work items, depending on the desired pipeline configuration.

To facilitate this, in embodiments, an indication of the respective shader program or programs specified to be executed for a pipeline stage is stored as part of the pipeline configuration information associated with, or accessible to, the pipeline stage in question. The iterator circuit when issuing a shading request to the graphics processor's set of shader cores for processing may thus be configured to indicate to the graphics processor's set of shader cores the respective shader program or programs to be executed based on the pipeline stage currently being executed. Thus, in embodiments, the set of pipeline configuration information that is used by the iterator circuit to control its processing of the sets of work (e.g. packets) to be processed for the different pipeline stages identifies the corresponding shader programs to be executed for the pipeline stages within the sequence of pipeline stages to be executed as part of the processing pipeline.

The shading request should also, and in embodiments does, indicate one or more memory locations containing the (input) packet(s) to be processed and/or for writing the (output) results. It will be appreciated that this is also done ‘generically’, such that the set of shader cores simply receives indications of (e.g. pointers to) input/output memory locations to be used, and these memory locations can include any desired packets to be processed, but the set of shader cores does not necessarily know which pipeline stages those packets relate to. This can therefore again increase flexibility/configurability of the processing pipeline.

After the required packet processing (e.g. shading) has been performed for a given packet of work items, the processed (shaded) output can be written to the respective portion of memory that was allocated for that packet, and the packet can be marked as complete, so that the packet is made available for output, e.g. to a next pipeline stage in the processing pipeline (or otherwise, e.g. if the current pipeline stage is the last pipeline stage), and subsequently output from the pipeline stage as appropriate, e.g. for further processing.

For example, and in embodiments, for each (child) output packet, a respective packet identifier identifying that packet is provided for output to the next pipeline stage, e.g. wherein the packet identifier will be added to the end of the work queue for the next pipeline stage, so that the packet can be processed accordingly by the next pipeline stage once the required packet processing (e.g. shading) has been performed.

The identifiers that are stored within the work queues may thus identify the sets of work (e.g. packets) to be processed, and contain any other information that may be needed by the pipeline manager to process and identify the packet.

These identifiers can thus be used to track work between the different pipeline stages. The identifiers that are stored within the work queues, in addition to identifying the respective sets of work to be processed, may also contain information needed by the iterator circuit to perform its processing. Alternatively, or additionally, some or all of this information may be stored in memory (i.e. alongside the packet payload data), and suitably fetched when the packet is provided to the iterator circuit for processing.

Various arrangements would be possible in this regard.

Another aspect of the processing pipeline according to the technology described herein is that the (generic) pipeline stages are generally operable and configured to process work items at a “packet” granularity, wherein a packet comprises a set of plural work items, but which work items may, e.g., depending on the pipeline stage in question and the processing to be performed for that packet, comprise any suitable and desired set of work items.

This packet-based processing can also provide increased flexibility and configurability in terms of the processing that may be supported by the processing pipeline according to embodiments of the technology described herein as the inputs/outputs for a particular pipeline stage can be more customised, e.g. since a packet that is input to or output from a given pipeline stage may generally contain any suitable group of work items (which may, e.g., be vertices, but could also be other geometry (or other) data), and these packets can be split, etc., to generate new (child) output packets, as required.

Again, therefore, the use of the processing pipeline according to the technology described herein may further increase flexibility/configurability compared to more traditional graphics processing pipelines, for example, in which each stage may have a stricter format for input data (e.g. a traditional vertex shading stage may require vertex data in a particular format), which may restrict options for the application programmer.

An effect and benefit of this is in embodiments then to facilitate more flexible and configurable graphics processor arrangements, e.g. since there may be fewer restrictions on the inputs/outputs to each pipeline stage, and the pipeline stages can be configured to map to, and hence support, various different graphics processing flows, as desired.

For example, in embodiments, the processing pipeline is a geometry processing pipeline that processes raw geometry that has been application-defined for a particular graphics processing operation into a suitable, e.g. screen-space, format version of that geometry for subsequent rendering of the geometry to produce a desired output (e.g. an image or other output). However, the geometry processing that is and can be supported in the technology described herein can comprise any suitable and desired sequence of one or more geometry processing stages that may be performed as part of a graphics processing pipeline.

In an embodiment, the geometry processing comprises one or more of, and in embodiments plural of, the following geometry processing stages: a position shader (position shading); a vertex shader (vertex shading); a tessellation control shader (tessellation control shading); a task shader (task shading); a tessellation stage (tessellation shading); a mesh shader (mesh shading); a tessellation evaluation shader (tessellation evaluation shading); a geometry shader (geometry shading); and a transform feedback stage (transform feedback shading).

The geometry processing may comprise one or more of these pipeline stages, as desired, and the processing pipeline can thus be configured to support various geometry processing flows, e.g., and in particular, by configuring different pipeline stages within the processing pipeline to trigger different shader programs as desired.

As discussed above, the processing pipeline according to the technology described herein includes a certain logical sequence of pipeline stages that can be, and is, implemented using a set of (generic) processing circuits that are effectively shared between the different pipeline stages. This set of (generic) processing circuits will include a iterator circuit, a set of work queues and a pipeline manager, as discussed above, and will have access to various shared storage. The logical sequence of pipeline stages that is executed using the set of (generic) processing circuits according to the technology described herein in embodiments comprises a sequence of shader stages, as discussed above.

However, subject to this, the overall processing pipeline may generally contain any suitable and desired pipeline stages and so could also, and in some embodiments does, include one or more other pipeline stages, as appropriate, which other pipeline stages may perform any other suitable processing operations, as desired, and may or may not be implemented using the same set of (generic) processing circuits that execute the pipeline (shader) stages.

For instance, ‘other’ pipeline stages might suitably be provided as a first and/or last pipeline stage in the processing pipeline that either provides packets to the (generic) pipeline stages or drains primitive packets therefrom, which might therefore desirably operate in a different manner to the intermediate pipeline stages, and various arrangements would be possible in this regard.

In this respect, embodiments relate to tile-based graphics processing including a binning stage that sorts geometry relative to the tiles. In that case, the geometry processing prior to the binning stage operates to generate respective (geometry) packets, each containing data for geometry to be processed. The binning stage then generates a data structure or structures to allow the packets storing data for geometry that apply to respective rendering tiles to be identified.

In such embodiments, the processing pipeline according to the technology described herein may thus perform the geometry processing prior to the binning stage of the tile-based graphics processing flow, and may, for example, process raw geometry that has been application-defined for a particular graphics processing operation into a suitable, e.g. screen-space, format version of that geometry for subsequent rendering of the geometry to produce a desired output (e.g. an image or other output).

The geometry processing generates respective (geometry) packets that each store data for a set of one or more primitives to be processed. In embodiments the first stage of the geometry processing, which in embodiments comprises position shading and/or vertex shading (comprising both position shading and varying shading, for example) acts as an “input packetizer” that generates initial packets storing data for sets of one or more primitives to be processed. These initial geometry packets are then in embodiments appropriately processed by (any) subsequent stages of the geometry processing to generate, for example, modified versions of the initial geometry packets and/or to generate additional geometry packets, as required. For example, a mesh shader may generate multiple packets from a single input packet.

Thus, in some embodiments, the geometry processing pipeline includes an “input packetizer” stage that may be, and in embodiments is, provided at the start (top) of the graphics processing pipeline, and that is operable to output initial packets storing data for sets of one or more primitives to be processed (and these initial packets are then passed from the “input packetizer” stage to the next pipeline stage for further processing). The processing pipeline may thus include an input packetizer stage that provides input packets for the processing pipeline.

The “input packetizer” stage, where present, may be, and in some embodiments is, a dedicated “input packetizer”, i.e. that is implemented using a standalone processing circuit, rather than using the iterator circuit described above. For example, the “input packetizer” stage could be a dedicated (e.g. hardware) unit that only creates input packets and outputs those packets to a next pipeline stage, without performing any further processing (e.g. shading). However, it would also be possible for the “input packetizer” stage to include a shading interface, and the “input packetizer” stage may also be implemented by the iterator circuit, if that is desired.

Various arrangements would be possible in this regard.

It will be appreciated that such “input packetizer” stage may not be required for all graphics processing flows. For example, when the geometry processing pipeline includes task/mesh shading stages (so that task/mesh shading is performed rather than traditional vertex shading) a dedicated input packetizer stage (circuit) may not be required since the task/mesh shaders can output their own vertices/primitives. Likewise, such “input packetizer” stage may not be required when the graphics processing pipeline is supporting general purpose (i.e. non-graphics) processing work.

Therefore, in embodiments, an/the “input packetizer” stage, where present, may be, and in embodiments is, selectively disabled in such cases.

Whether the “input packetizer” is enabled or not may be defined as part of the overall pipeline configuration information for the processing pipeline.

The pipeline configuration information may also define any other suitable and desired pipeline configuration information or parameters that may be used to execute some or all of the processing pipeline.

For example, as mentioned above, the pipeline configuration information may include both configuration information relating to the processing pipeline as a whole, and configuration information relating to the individual pipeline stages within the processing pipeline.

Examples of configuration information relating to the processing pipeline as a whole may thus include the “input packetizer” configuration, the number of pipeline stages, viewport parameters, etc., as well as a memory pool configuration available to the pipeline stages, and any other suitable and desired information that may be defined for the processing pipeline as a whole.

Examples of configuration information relating to the individual pipeline stages within the processing pipeline may then include an identification of a particular shader program that is to be invoked for that pipeline stage, as well as any other suitable and desired information that may be defined on a per pipeline stage basis.

For example, this per pipeline stage configuration information may also define a so-called ‘workgroup size’ for the pipeline stage. This workgroup size may, for example, dictate (at least in part) the number of output packets to be produced by the pipeline stage for an incoming packet.

For example, in embodiments, packets may need to be split into plural “child” output packets when dictated by the workgroup (job) size for the shader programs that are specified to be executed for the pipeline stage in question. This may also be the case wherein the data structures used to store packets are configured to store up to (fixed) maximum number of work items, and wherein the processing within a particular pipeline stage involves amplification of work items.

It will be appreciated that when executing a processing pipeline in which a stage or stages of the pipeline generate data for use by later stage(s) of the pipeline, there may be a need for the data generated by the stage(s) to be stored for subsequent use by other pipeline stage(s), and for those other pipeline stage(s) to be able to access that data appropriately.

For a packet of work items that is to be further processed within the pipeline stage (e.g., and in particular, for each “child” output packet to be produced), the iterator circuit is in embodiments then operable to allocate, for the packet, a respective portion of memory for (temporarily) storing data for that packet.

The memory that is available for storing (data for) packets can generally be any suitable and desired memory and can be configured in various ways. In embodiments, however, the memory that can be allocated for storing (data for) packets is portioned into a plurality of memory “pools”, each memory pool being associated with one or more pipeline stages. This can then help with memory management, in particular managing data dependencies between pipeline stages.

A given pipeline stage may therefore be associated with at least one memory pool that it is able to allocate portions of for temporarily storing data for packets of work items that are to be processed within that pipeline stage.

In embodiments, each pipeline stage (including the input packetizer, when present) other than the (final) (primitive) packet draining stage, where this is present, has an associated memory pool from which it can allocate respective portions for temporarily storing data for packets of work items that are to be processed within that pipeline stage.

Various arrangements would be possible in this regard.

A given (generic) pipeline stage may thus allocate respective portions of its memory pool for respective packets that are processed/generated within that pipeline stage. There may, however, then be one or more other, later pipeline stages that also potentially need to access (data for) packets that were generated/processed by an earlier pipeline stage. That is, data generated by a particular, earlier pipeline stage in respect of a packet may also be required as input for the processing of corresponding (child) packets in certain, later pipeline stages. Such later pipeline stages should therefore, and in embodiments do, also have access to any memory pools storing data that may be needed by such later pipeline stages. Such later pipeline stages can in embodiments also update the data within such memory pools, but cannot perform new allocations within such memory pools.

That is, in embodiments, for a particular instance of graphics processing pipeline execution (e.g. for a particular render pass or draw call within a render pass), only a single pipeline stage should be permitted to allocate portions of any given memory pool (and the memory pool is thus associated with that single pipeline stage), but once a portion of a memory pool has been allocated for storing data for a particular packet, other, later pipeline stages that may need that data are in embodiments also able to access/update (data in) that memory pool as needed.

This memory (pool) assignment is in embodiments performed in advance during an initial configuration of the processing pipeline. That is, when the processing pipeline is being configured, a set of memory pools are in embodiments configured, and appropriate access permissions are set for each of the pipeline stages to the respective memory pools. For example, a suitable indicator of which pipeline stages can access which memory pools can be generated during the initial pipeline configuration. This indicator may, e.g., take the form of a ‘bit mask’ per memory pool indicating which pipeline stages can access that memory pool, but other arrangements would of course be possible.

Thus, the access permissions may be flexibly re-configured for different instances of executing the processing pipeline (e.g. between render passes or draw calls), but should be, and in embodiments therefore are, fixed for a particular instance (or set of instances) of the processing pipeline.

The first pipeline stage that can access a given memory pool is thus permitted to allocate portions of that memory pool (and it is in embodiments only the first pipeline stage that is permitted to allocate portions of the memory pool). Any other pipeline stages that are permitted to access the memory pool are thus in embodiments able to read data from, and in embodiments also update data within, the memory pool, but are in embodiments unable to allocate portions of the memory pool (and instead, those pipeline stages may, and typically will, be associated with another, separate memory pool from which they can allocate portions for work items being processed/generated by those pipeline stages).

As mentioned above, there is in embodiments a shared memory management system that is operable and configured to then manage any accesses to the memory pools by the pipeline stages (and enforce such access permissions).

The memory pools that are available and associated with the different (generic) pipeline stages may reside in any suitable and desired memory accessible by the graphics processor. For instance, in embodiments, the memory pools from which the (generic) pipeline stages are able to allocate respective portions of may be partitioned from within an overall geometry buffer.

Various arrangements are however contemplated in this regard.

The (data generated for) packets of work items being processed by a particular pipeline stage can thus be written to the associated memory pool for that pipeline stage (i.e. the memory pool from which that pipeline stage can allocate respective portions). For example, as mentioned above, for a (child) packet of work items that is to be further processed within a particular pipeline stage, a respective portion of the associated memory pool for that pipeline stage can be temporarily allocated for use by that packet, as required. A suitable packet identifier (e.g. included within a packet header) can thus be written to the allocated portion of the associated memory pool to reserve that portion. Any data (elements) generated for a packet can then be written to the respective portion of the memory pool that has been allocated for that packet during the processing of the packet.

Further, the data (elements) generated for a packet, and stored in a respective portion of a memory pool, can then be read from, and in embodiments also updated by, subsequent pipeline stages, as needed.

The initial assignment of the memory (pools) to the (generic) pipeline stages, and setting of the relevant access permissions, during the overall pipeline configuration thus controls and facilitates the data flow along the processing pipeline. For example, even when different (logical) pipeline stages share the same underlying physical circuits, different (generic) pipeline stages in embodiments have respective, different memory pool ‘carveouts’from which they can allocate respective portions of for temporarily storing data (elements) generated for packets it is processing (with other pipeline stages potentially being permitted to read/update data from that memory pool, as appropriate based on the pipeline configuration, but being prohibited from allocating portions of that memory pool (and instead having their own associated memory pool from which they can allocate portions for temporarily storing data (elements) generated for packets being processed by those pipeline stages).

The above describes the main elements and operation of the graphics processor and processing pipeline that are relevant to operation in the manner of the technology described herein.

The technology described herein can be used for all forms of output that a graphics processor and processing pipeline may be used to generate. In particular, the technology described herein may be used both for generating graphics processing outputs, such as frames for display, render to texture outputs, etc., or for general purpose (non-graphics) outputs.

As will be appreciated by those skilled in the art, the graphics processor can otherwise include and execute, and in embodiments does include and execute, any one or one or more, and in embodiments all, of the pipeline stages and circuits that graphics processors and processing pipelines may (normally) include.

Thus, for example, the graphics processor may execute a processing pipeline that includes one or more geometry pipeline stages, such as vertex shading, task shading, mesh shading, tessellation shading, etc., and execute one or more rendering stages, such as rasterization and fragment shading stages, and/or appropriate ray tracing stages. In an embodiment the graphics processor is in the form of a tile-based graphics processor and so also includes and executes an appropriate tiling/binning stage or stages.

Correspondingly, the graphics processor may include any one or more of, and in embodiments plural of: one or more geometry processing circuits, primitive assembly circuit or circuits, a tiling/binning circuit or circuits, a primitive setup circuit, a rasteriser circuit and a renderer circuit (in embodiments in the form of or including a programmable fragment shader), a depth (or depth and stencil) tester, a blender, a tile buffer, a write out circuit, etc..

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus, it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc.. In an embodiment, the output is an output frame, and in embodiments an image. However, in general the graphics processors (and processing pipelines) of the technology described herein may be used both for performing graphics processing work, such as generating frames for display, etc., or for performing general purpose (non-graphics) work, as desired.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, etc., of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various pipeline stages may share processing circuitry/circuits, etc., if desired.

Furthermore, unless otherwise indicated, any one or more or all of the pipeline stages of the technology described herein may be embodied as pipeline stage circuits, e.g., in the form of one or more fixed-function units (hardware) (processing circuits), and/or in the form of programmable processing circuits that can be programmed to perform the desired operation. Equally, any one or more of the pipeline stages and pipeline stage circuitry of the technology described herein may be provided as a separate circuit element to any one or more of the other pipeline stages or pipeline stage circuits, and/or any one or more or all of the pipeline stages and pipeline stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may in embodiments provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

Embodiments of the technology described herein will now be described.

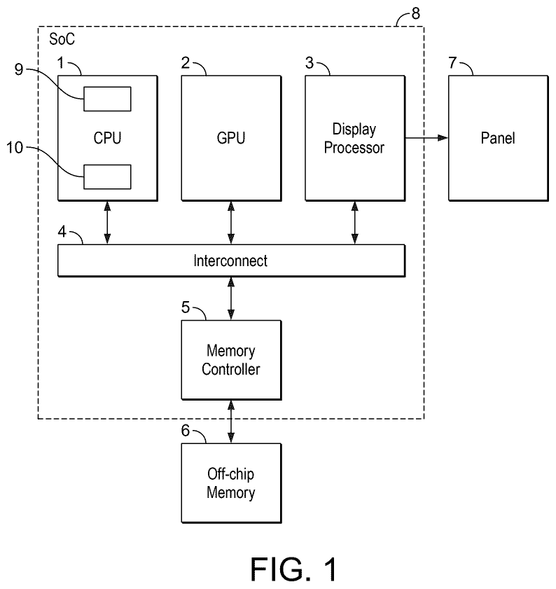

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

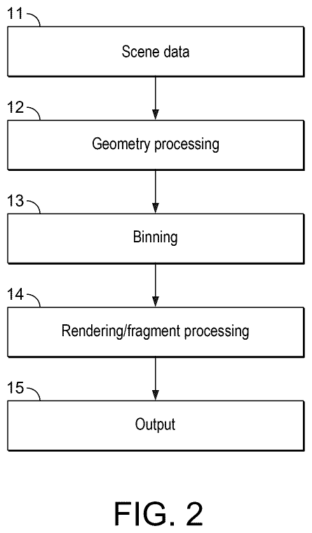

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in embodiments, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry pipeline stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13.

(It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning/tiling process 13 operates to generate appropriate data structures for determining which primitives need to be processed for respective rendering tiles of the output being generated.

For example, the binning/tiling process 13 may sort the primitives into appropriate primitive lists, which indicate the primitives to be processed for respective tiles or sets of tiles. Alternatively, the binning/tiling process 13 may generate other data structures, such as hierarchies of bounding boxes, that can then be used at the rendering/fragment pipeline stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process 13 has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing 14 can comprise any suitable and desired rendering and fragment processing operations that may be performed. Thus, it may comprise, for example, first rasterising primitives to be processed for a tile to fragments, and then processing those fragments accordingly (e.g., and in embodiments, by performing appropriate fragment shading of the fragments). The rendering/fragment processing 14 may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing 14 (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc..

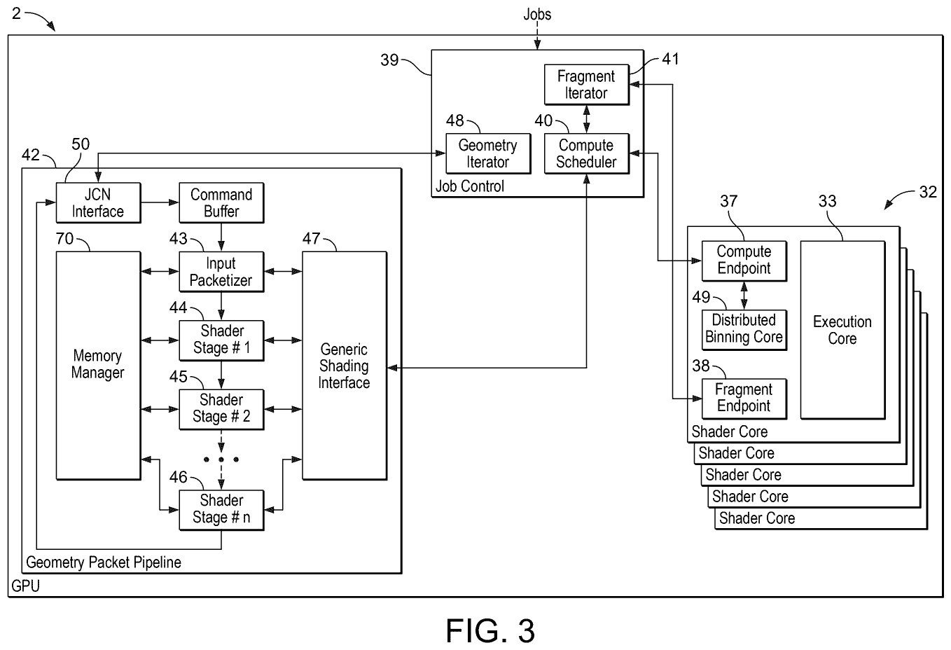

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

Each execution core 33 has appropriate access to a memory system 6 of the data processing system that the graphics processor 2 is part of.

In the present embodiments, the shader cores 32 are operable to execute both “compute” shader programs (to perform so-called compute shading) and fragment shader operations. Thus, as shown in FIG. 3, each shader core 32 comprises an appropriate compute endpoint 37 and fragment endpoint 38 that act as the control interface for performing compute shading and fragment processing, respectively, and that will, for example, and in embodiments, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing pipeline stage determines the vertex and other data that is necessary for generating the graphics processing output in question, which will then be followed by a rendering/fragment pipeline for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” pipeline stages (which pipeline stages themselves will be executed by the shader cores 32, under the control of the geometry packet pipeline 42).

For example, as shown in FIG. 3, the geometry packet pipeline 42 comprises an input packetizer 43 that can trigger position shading and vertex shading by the shader cores 32. It also includes further pipeline stages 44, 45, 46 that are operable to trigger compute shaders (shader programs) for performing geometry processing, such as task shaders, mesh shaders, tessellation shaders, etc., (which shaders again will be executed by the shader cores 32).

As shown in FIG. 3, the geometry packet pipeline 42 thus has an appropriate interface, in the form of shading manager 47, to the compute scheduler 40 of the job control unit 39, via which it can control and trigger the performance of appropriate geometry shading operations by the shader cores 32.

The geometry packet pipeline 42 also has an appropriate interface, in the form of memory manager 70, to the memory system 6, in which appropriate storage is allocated for storing the geometry packets that will be produced and processed by the geometry packet pipeline 42 (although this off-chip memory 6 will typically be accessed via a cache system, such that at least some packets may be held entirely locally to, and on-chip with, the graphics processor 2 in use, without ever being written out to the off-chip memory 6). The geometry packet pipeline 42 thus also has a shared memory manager 70 which manages the memory allocations and deallocations for temporary packet data for each of the pipeline stages.

In general, any suitable memory may be used to support the geometry packet pipeline 42. In the present embodiments, however, this memory is in the form of a set of memory pools, with respective memory pools being assigned to respective, different pipeline stages within the geometry packet pipeline 42.

Thus, for instance, different pipeline stages may be allocated different portions within an overall, shared geometry buffer that is backed by the off-chip memory system 6.

When a pipeline stage is processing a packet input to that pipeline stage, depending on the pipeline stage in question, the pipeline stage may accordingly allocate a respective portion of memory for storing the output packet(s) that will be produced by the processing of the packet.

In this respect, a given pipeline stage may only allocate memory within the respective memory pool assigned to that stage (and, typically, only one pipeline stage is able to allocate within a given memory pool, although other pipeline stages may still access the data within that memory pool).

For example, the first pipeline stage accessing a given memory pool may always allocate packets to that memory pool. Correspondingly, the last pipeline stage accessing a given memory pool is then operable to trigger de-allocation of packets for that memory pool. Any intermediate pipeline stages can only access the memory pool, e.g. by reading and/or writing an already allocated packet (but cannot perform any memory allocations/de-allocations).

As will be explained further below, each pipeline stage also maintains a packet queue storing packet identifiers, in the form of packet “headers” identifying the packets to be processed (and the location of the payload data for those packets). The packet queue is operated in a ‘first-in-first-out’ (FIFO) manner so that packets are kept strictly in the order the associated packet payloads were allocated. Since allocations and deallocations in the memory pool should always happen in order, this then avoids any need to track individual allocations.

The overall operation of the geometry packet pipeline 42 is controlled, and triggered, by the job control unit 39 (by a geometry iterator 48 of the job control unit 39) which distributes the appropriate geometry processing jobs and tasks to the geometry packet pipeline 42. The geometry packet pipeline 42 will thus have a respective interface 50 to the job control unit 39 via which commands and status updates can be signalled.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated (i.e. to implement the binning/tiling process 13).

In the present embodiments, the distributed binning cores 49 generate hierarchies of bounding boxes for primitives and primitive packets (that contain primitives to be rendered) (which are then used at the rendering/fragment pipeline stage 14 to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

As shown in FIG. 3, the distributed binning cores 49 of the shader cores 32 may also trigger compute shading, via the compute endpoint 37. For example, the distributed binning cores 49 of the shader cores 32 may in some instances trigger some or all of the vertex shading, such as varying shading, as part of their operation (e.g., and in particular, where varying shading was not performed by the input packetizer as part of the input packetizer 43 operation).

Various arrangements would be possible in this regard.

In the present embodiments, the rendering/fragment processing 14 is performed by executing appropriate fragment processing operations on a shader core 32 under the control of the fragment frontend 38. To facilitate this, as shown in FIG. 3, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes (which data can be respectively considered to be corresponding data elements (e.g. positions or varyings, in the case of vertices) for corresponding work items (e.g. vertices)), which data will then be used, for example, by the binning/tiling processing 13 and rendering/fragment processing 14 of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders).

Thus, in the present embodiments, the geometry packet pipeline 42 will generate work item packets, in the form of geometry packets, that store data elements (attributes) for work items (such as vertices and primitives), which geometry packets will then be read and used by the distributed binning cores 49. Correspondingly, the distributed binning cores 49 will generate appropriate primitive packets storing data elements (attributes) for work items, such as vertices and primitives, which primitive packets will then be read and used by the fragment processing 38.

Various other arrangements would of course be possible. For example, rather than the geometry packet pipeline 42 generating geometry packets that are then read and used by the distributed binning cores 49 as shown in FIG. 3, the geometry packet pipeline 42 could interface and provide geometry packets to a tiling unit that then performs more traditional tiling operations, e.g. in the normal (serialized) manner for tile-based graphics processing, using the geometry packets.

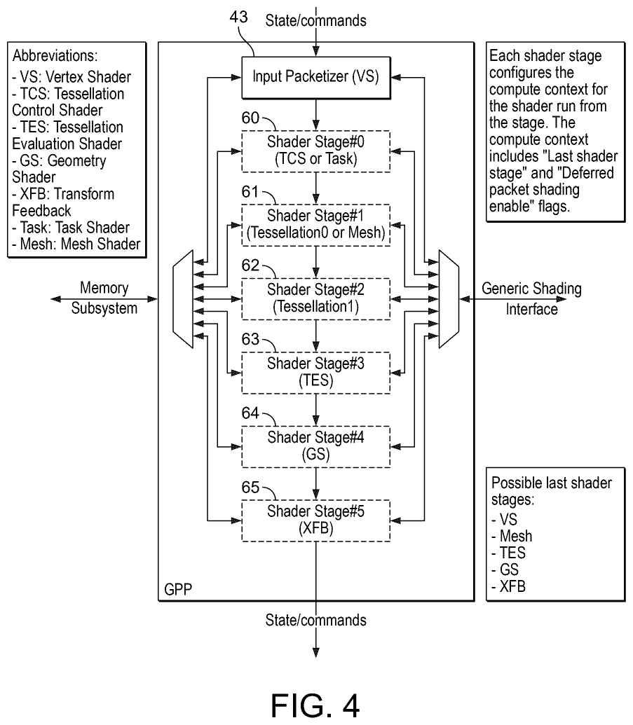

FIG. 4 shows in more detail one possible example of a geometry packet pipeline 42 that may be executed according to the present embodiments.

In particular, as shown in FIG. 4, in the present embodiments the geometry packet pipeline 42 comprises (can trigger the execution of) a sequence of six pipeline stages, an input packetizer 43 (can trigger vertex shading (VS)) a next pipeline stage 60 that can trigger tessellation control shading or task shading, a next pipeline stage 61 that can trigger tessellation shading or mesh shading, a next pipeline stage 62 that can trigger further tessellation shading, a next stage or stage 63 that can trigger tessellation evaluation shading, a next stage or stage 64 that can trigger geometry shading, and a final pipeline stage 65, that can trigger transformed feedback shading.

As mentioned above, the input packetizer 43 reads the index array and builds packets that can be used by the rest of the pipeline.

Thus, in the present embodiments, the only shading that can be (and is) invoked by the input packetizer 43 is vertex shading (which can be position-only vertex shading or combined position and varyings shading). The input packetizer 43 can also be selectively disabled and/or enabled without shading and populated with (pre-shaded) input vertices, depending on the particular processing operations to be performed.

Once a packet has been fully populated by the input packetizer 43 (when this is done), the packet is sent to the next stage in the geometry processing pipeline 42 which then processes the incoming packet, and triggers any desired shader execution, e.g. as described above.

In operation, each pipeline stage of the geometry packet pipeline 42 will configure the compute context for the shader that is run from the stage in question (with this compute context being signalled to the compute scheduler 40 accordingly via the shading manager 47).

Thus, as described above, the geometry processing pipeline 42 further includes a plurality of pipeline stages 60-61-62-63-64-65 that can be, and are, dynamically configured in advance of geometry processing pipeline 42 execution as respective pipeline stages to perform the desired pipeline operations.

Various arrangements would be possible in this regard.

FIG. 4 thus illustrates the logical data flow according to the geometry packet pipeline 42.

As shown in FIG. 4, there will be a certain sequence of pipeline stages to be executed within the geometry packet pipeline 42.

According to the present embodiments, however, as will be explained further below, rather than providing dedicated hardware circuitry to support a particular configuration of the geometry packet pipeline 42, some or all of the pipeline stages that are to be executed as part of the geometry processing pipeline 42 are executed using a set of shared processing circuitry (hardware).

This then means that any or all of the pipeline stages 60-61-62-63-64-65 may be implemented generically in hardware with the same set of shared processing circuits. The processing circuits are then controlled based on suitable software configuration to perform appropriate processing operations to execute the various different pipeline stages.

Thus, as will be explained further below, there may be an initial configuration of the geometry packet pipeline 42 in which the processing circuits are configured to perform certain processing operations based on that initial configuration (and this initial configuration may be performed in advance, e.g. prior to starting a first render pass). Subsequent state changes may also be passed down the geometry packet pipeline 42 to update/set state as needed, e.g. between render passes, or even between draw calls within a render pass.

That is, although the various pipeline stages 60-61-62-63-64-65 are depicted in FIG. 4 as separate stages, and at least from a logical perspective are treated as separate stages defining the geometry packet pipeline 42, the pipeline stages 60-61-62-63-64-65 are executed using a shared set of shared physical processing circuits, with those processing circuits being controlled to execute different logical pipeline stages, as desired, and with the data flow between pipeline stages thus being managed appropriately, e.g. using respective packet queues and memory pool allocations, as will be explained further below.

When work is to be performed using the geometry packet pipeline 42, this can thus be triggered by issuing a suitable command (e.g. a ‘RUN_PIPELINE’ command) to the geometry processing pipeline 42, and such command will cause work to be launched on the first enabled stage in the geometry processing pipeline 42. This first stage may be the input packetizer 43 or a subsequent pipeline stage depending on the particular operations to be performed (e.g., and in particular, whether the input packetizer 43 is present/enabled).

The first pipeline stage may then request from the memory manager 70 to allocate a packet in a respective memory pool tied to the first pipeline stage. If allocation succeeds, the first stage then issues a shading request via its generic shading interface 47 in respect of the packet to the compute scheduler 40 within the job control unit 39 of the graphics processor 2, which compute scheduler 40 then schedules a corresponding one or more processing tasks to respective compute endpoints 37 of the shader cores 32. The shader program run on the packets issued by a particular stage is in the present embodiments defined by a unique shader program descriptor for the stage, which is configured as part of the initial pipeline configuration.

Consecutive packets issued for shading are thus distributed to available shader cores 32 in this way with the packet shading being controlled via the compute shader scheduler 40 (and compute endpoints 37).

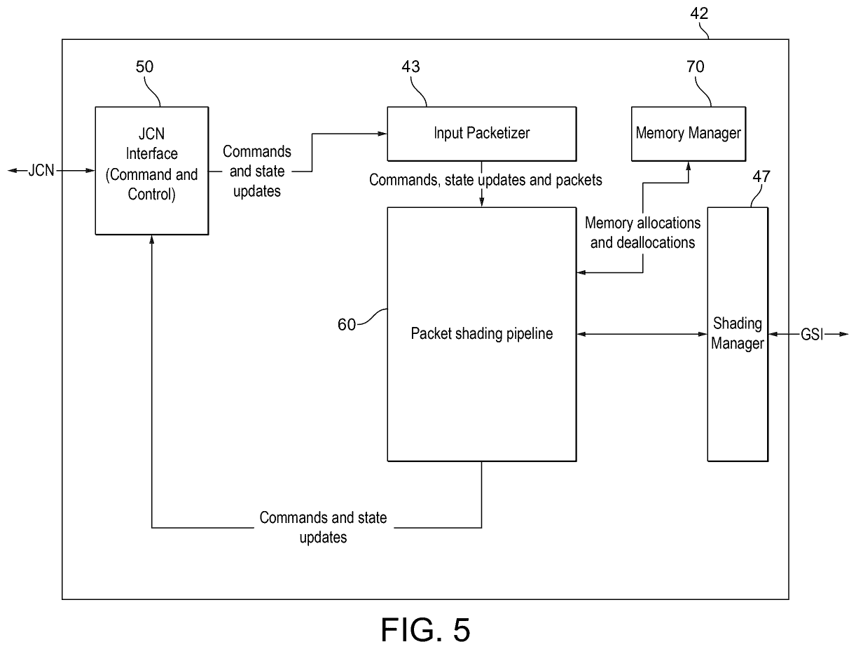

FIG. 5 shows a simplified high-level view of the geometry packet pipeline 42 described above to illustrate how the geometry packet pipeline 42 may be supported in hardware according to an embodiment.

In particular, in this example, any of the pipeline stages that follow the input packetizer 43 (e.g. pipeline stages 60-61-62-63-64-65 in FIG. 4), which pipeline stages are denoted in FIG. 5 as the packet shading pipeline 60, are all executed using a set of shared processing circuits (hardware). The processing circuitry that executes the packet shading pipeline 60 thus contains suitable processing logic to execute the required pipeline stages within the packet shading pipeline 60. This processing circuit also interfaces with the other stages within the geometry packet pipeline 42, as appropriate. For instance, as shown in FIG. 5, the packet shading pipeline 60 is operable to communicate with (and receive packets) from the input packetizer 43, and to communicate with the memory manager 70 and shading manager 47 as part of its execution of the different pipeline stages 60-61-62-63-64-65 to be executed.

As shown in FIG. 5, the packet shading pipeline 60 is also operable to communicate with the job control network interface 50 via which geometry processing work is submitted to the geometry packet pipeline 42 (from the geometry iterator 48). The packet shading pipeline 60 may for example signal commands and state updates back to the job control network interface 50.

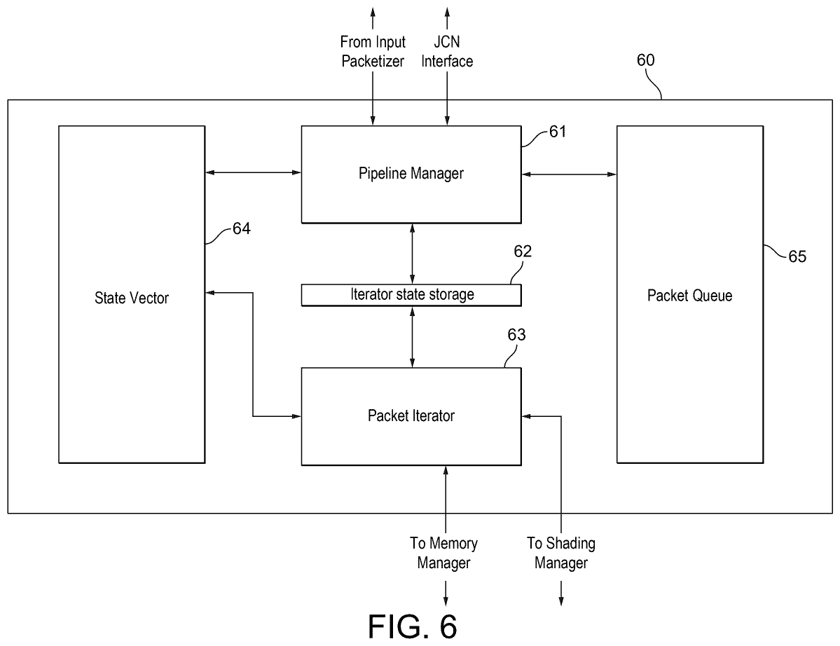

FIG. 6 shows in more detail the processing logic to execute the different pipeline stages 60-61-62-63-64-65 within the packet shading pipeline 60 according to the present embodiments.

As shown in FIG. 6, the packet shading pipeline 60 has access to a work buffer, in the form of shared packet queue 65, which is a shared resource that stores the packets for each of the different pipeline stages 60-61-62-63-64-65 within the packet shading pipeline 60.

In this regard, it will be appreciated that the number of pipeline stages 60-61-62-63-64-65 within the packet shading pipeline 60 in the present embodiments is configurable, and so the number of pipeline stages 60-61-62-63-64-65 configured within the packet shading pipeline 60 may change over time.

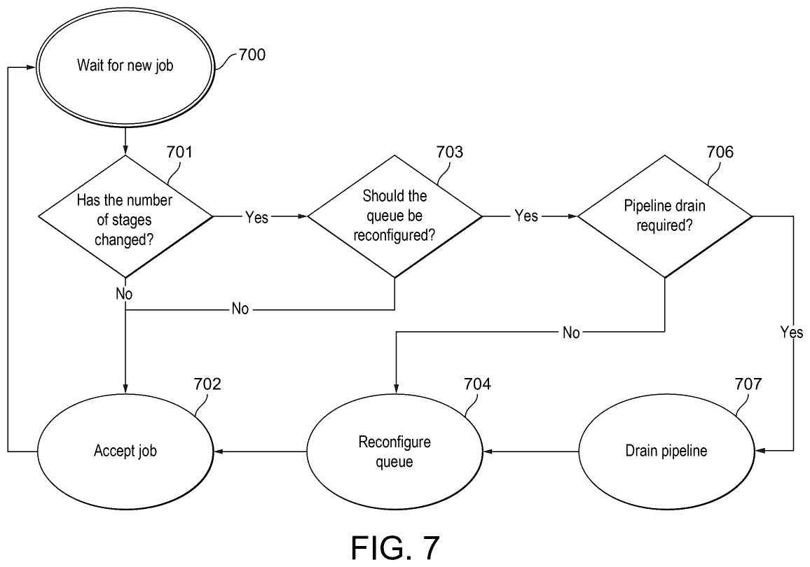

FIG. 7 is a flow chart illustrating a configuration process according to an embodiment. As shown in FIG. 7, in response to the geometry iterator 48 issuing a new processing job that will use the geometry packet pipeline 42, when the job is received (step 700), it is determined whether or not the number of pipeline stages to be executed within the packet shading pipeline 60 of the overall geometry packet pipeline 42 has changed (step 701). If not (step 701—no), the processing job can be accepted (step 702). The interface 50 to the job control network can therefore signal to the geometry iterator 48 that the job is accepted, and the processing pipeline execution can be triggered appropriately. On the other hand, if the number of pipeline stages to be executed within the packet shading pipeline 60 of the overall geometry packet pipeline 42 has changed (step 701—yes), it is then checked whether the shared packet queue 65 should be reconfigured.

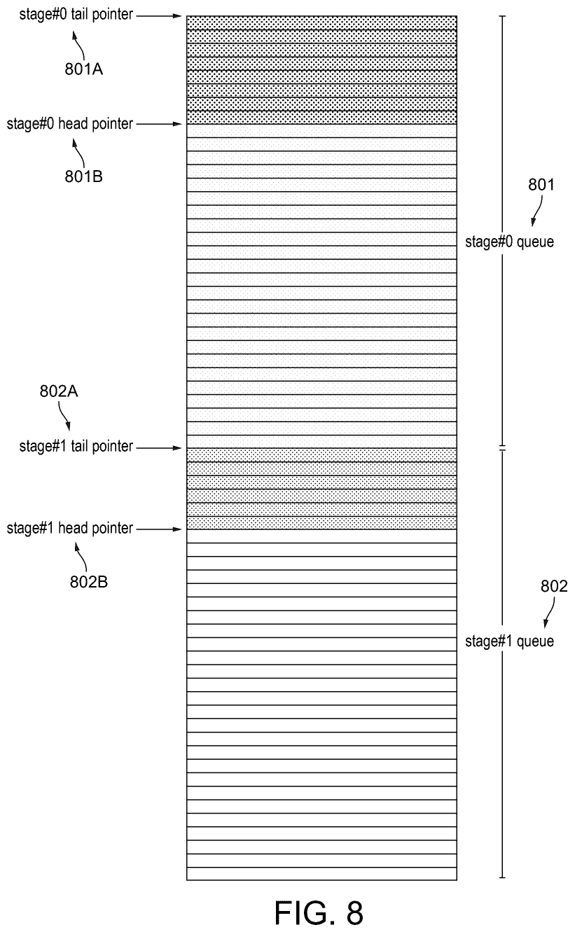

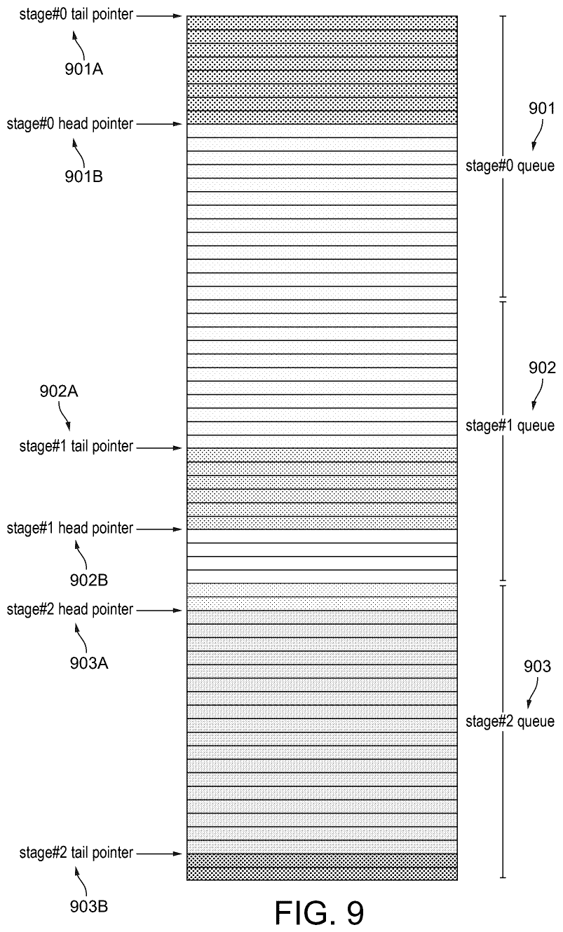

For example, in the present embodiments, the shared packet queue 65 is partitioned based on the number of pipeline stages to be executed within the packet shading pipeline 60. Thus, FIG. 8 shows one example where the shared packet queue 65 is partitioned into a first packet queue 801 that identifies respective packets to be processed for a first pipeline stage (‘pipeline stage O’) and a second packet queue 802 that identifies respective packets to be processed for a second pipeline stage (‘pipeline stage 1’). Each partition/packet queue 801/802 further comprises respective head and tail pointers 801A, 801B/802A, 802B for identifying the currently valid section of the partition/packet queue 801/802. FIG. 9 then shows another example in which the (same) shared packet queue 65 is now partitioned into three respective packet queues 901, 902, 903, which each partition/packet queue 901/902/903 again having its own set of head and tail pointers 901A, 901B/902A, 902B/903A, 903B identifying the currently valid section of the partition/packet queue 901/902/903.

Thus, the shared packet queue 65 can be reconfigured to support different numbers of pipeline stages. That said, in some situations, it may nonetheless be desirable to not reconfigure the shared packet queue 65. That is, there may be a certain cost associated with reconfiguring the shared packet queue 65, and so in some cases it may be better not to reconfigure the shared packet queue 65. In that case, a particular partition that was configured to a particular pipeline stage that is no longer required may simply be unused.

Various suitable metrics may be used to determine whether or not the partitioning of the shared packet queue 65 should be reconfigured.

Accordingly, if it is determined that the shared packet queue 65 should not be reconfigured (step 703—no), the job is simply accepted (step 702), as above. Whereas, if it is determined that the shared packet queue 65 should be reconfigured (step 703—yes), this is done (in step 704), but it is first checked whether or not it is required to first drain the geometry packet pipeline 42 of work before the shared packet queue 65 is reconfigured. For example, this may be appropriate to avoid data entries spilling between different pipeline stages. Thus, if it is required to drain the geometry packet pipeline 42 of work (step 706—yes), this is then done (step 707) before the shared packet queue 65 is reconfigured (step 704). On the other hand, if it is not required to drain the geometry packet pipeline 42 of work (step 706—no), the shared packet queue 65 can be reconfigured immediately (step 704). Once the shared packet queue 65 has been reconfigured (in step 704), the job can then be accepted (step 702), as above.

As shown in FIG. 6, the shared packet pipeline 60 is executed using an iterator circuit, in the form of packet iterator 63, that, as will be explained further below, is operable to control the processing of packets for each and any of the different pipeline stages 60-61-62-63-64-65 to be executed as part of the packet shading pipeline 60.

To manage this operation, there is further provided a pipeline manager 61 that is operable to provide packets from the shared packet queue 65 to the packet iterator 63 for processing.

Although FIG. 6 shows only a single packet iterator 63 and pipeline manager 61 (and the technology described herein can be, and in embodiments is, implemented using only a single packet iterator 63 and pipeline manager 61 as shown in FIG. 6), it will be appreciated that in general the shared packet pipeline 60 may be implemented using multiple packet iterators, and/or pipeline managers, which can be shared as appropriate between different pipeline stages. For example, a single pipeline manager 61 could provide packets for processing to multiple packet iterators 63, so long as any processing conflicts are appropriately handled. In the present embodiments, however, there is only a single packet iterator 63.

It will be appreciated in this respect that the packet iterator 63 is operable to process packets for any of the pipeline stages 60-61-62-63-64-65 to be executed, and that the packet iterator 63 is essentially generic in that it operates to perform the same basic processing operations for packets that are received from any of the different pipeline stages 60-61-62-63-64-65, but in such a manner that different processing operations are performed, as appropriate, for the different pipeline stages.

In particular, as will be explained further below, the packet shading pipeline 60 will, when processing a packet for a particular one of the pipeline stages 60-61-62-63-64-65 to be executed, trigger execution of the required compute shader for that pipeline stage, by issuing an appropriate request to the shading manager 47 specifying which computer shader is to be executed. The packet shading pipeline 60 will also perform, via the memory manager 49, any required memory allocations/deallocations that should be performed as part of the processing of a packet for the pipeline stage being executed.

For instance, it will be appreciated that the number and type of pipeline stages 60-61-62-63-64-65 to be executed is configurable. This is defined by an appropriate set of configuration state, in the form of state vector 64, that defines the current configuration of the packet shading pipeline 60.

The state vector 64 thus indicates, for a given processing job, the number and type of pipeline stages to be executed, as well as the state that is to be used when executing those pipeline stages.

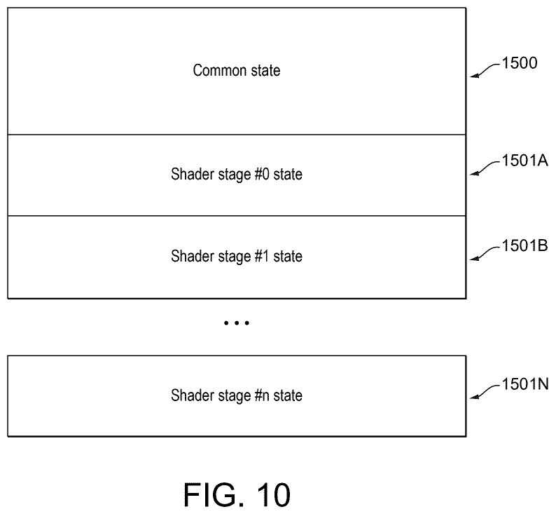

As shown in FIG. 10, the state vector 64 will generally store both common state 1500 that is to be used by the geometry packet pipeline 42 as a whole.

This common state 1500 may, for example, include viewport parameters, the input packetizer 43 configuration, the configuration of memory pools for the different pipeline stages, and any other suitable state/parameters that may desirably be stored for the geometry packet pipeline 42 as a whole.

The state vector 64 will also store, for each pipeline stage, respective per-pipeline stage state 1501A, 1501B, . . . , 1501N. The per-pipeline stage state may for example define the type of pipeline stage (which will in turn define the shader program that is to be invoked for that pipeline stage), the workgroup size for that pipeline stage, the amount of expansion that is to be performed for packets, and any other suitable state/parameters that may desirably be stored for the respective pipeline stages within the packet shading pipeline 60 portion of the geometry packet pipeline 42.

The configuration state will then be used by the packet iterator 63 to control processing of packets according to the desired pipeline stage configuration, e.g. to trigger the appropriate compute shading, etc., to execute the pipeline stage.

The initial pipeline configuration in the present embodiments may thus involve any, and in embodiments all, of: (i) enabling one or multiple stages of the geometry packet pipeline; (ii) configurating a shader program descriptor for each enabled stage; (iii) configuring workgroup dimensions for each stage; (iv) configuring one or more memory pools and binding each memory pool to a unique stage responsible for allocating packets in the memory pool; (v) configuring a packet size and layout for each memory pool; and (vi) setting a memory pool access mask for each memory pool indicates which pipeline stages can access the memory pool (with the first stage accessing a given memory pool always being the stage to allocate portions of that memory pool and the last stage accessing the memory pool always being the state to de-allocate portions of that memory pool).

Further, this is in embodiments all done under the control of the pipeline manager 61. For instance, the pipeline manager 61 is in the present embodiments operable to select a packet to be processed next from the shared packet queue 65, which packet may therefore be a packet that is to be processed for any of the pipeline stages 60-61-62-63-64-65 within the packet shading pipeline 60, and to provide the selected packet to the packet iterator 63 for processing.

To facilitate this processing, the pipeline manager 61 may also therefore provide the packet iterator 63 with the required state information as stored within the state vector 64 that is needed to execute the pipeline stage in question for which the packet is being processed.

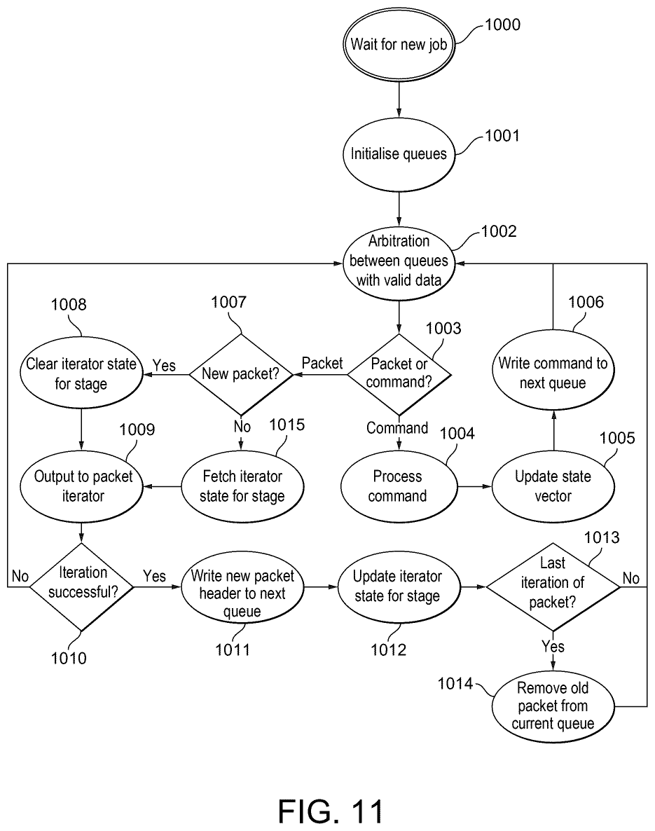

FIG. 11 is a flow chart illustrating the pipeline manager 61 operation according to the present embodiments. In FIG. 11, the pipeline manager 61 is responsible for configuring the shared packet queue 65 (i.e. as described above in FIG. 7). Thus, the pipeline manager 61 is operable to receive processing jobs via the job control network interface 50 (step 1000), and in response to receiving a new processing job, the pipeline manager 61 will then configure the shared packet queue 65 appropriately for the new processing job (step 1001).

Once the shared packet queue 65 is configured, the pipeline manager 61 will then start to select items for processing (step 1002). The pipeline manager 61 may generally select a next item for processing from either the input packetizer 43 or from the heads of any of the packet queues/partitions within the shared packet queue 65, so long as those packet queues/partitions contain valid data. Thus, initially, the pipeline manager 61 may receive input packets/commands from the input packetizer 43, and trigger processing of these packets by the first pipeline stage, etc.. Over time, however, there will be items available to be processed for any of the pipeline stages. The pipeline manager 61 should therefore, and does, perform arbitration between the items from the input packetizer 43 and the head items from the various packet queues/partitions within the shared packet queue 65.

Any suitable and desired arbitration scheme may be used in this respect by the pipeline manager 61 to select which item(s) should be processed next, so long as progress can be made.

In the present embodiments, in addition to the packets that are processed, processing commands, e.g. to start a processing job, and/or to update the state vector 64, are also processed by the geometry packet pipeline 42.

Thus, in the present embodiments, packets of work items to be processed and packets of state are both passed through the pipeline stages in a similar manner. This then allows state updates can be propagated through the pipeline stages to allow the graphics processing pipeline to be appropriately updated/re-configured for different instances of graphics processing pipeline execution.

Thus, when the pipeline manager 61 selects an item to be processed, this could either be a packet for which a pipeline stage is to be executed. Or, the next item could be a command. If the item is a command (step 1003—command), the command is then processed accordingly (step 1004), e.g. to update the state vector 64 (step 1005). The command is then written into the respective packet queue/partition for the next pipeline stage (step 1006), so that the command can be propagated through the pipeline, with the state vector 64 being incrementally updated as needed.

Thus, in the present embodiments, any commands/state updates are processed by the pipeline manager 61.

Various arrangements would be possible in this regard.

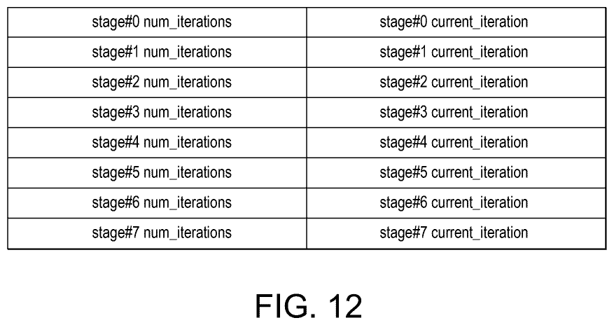

On the other hand, when the item is a packet (step 1003—packet), the pipeline manager 61 then checks whether this is a new packet (step 1007), or whether the packet is a packet that has already been partly processed. In this respect, it will be appreciated that a given pipeline stage may perform packet expansion in which a single input packet generates multiple output packets. The packet iterator 63 that is used in the present embodiments is however restricted to only process a single packet at a time. This is because the packet iterator 63 will not know in advance which pipeline stage is being executed, and whether there will be sufficient free memory available to be allocated in a memory pool allocated to that pipeline stage for each of the potential output packets to be generated. Thus, rather than sending a single packet and having the packet iterator 63 try to manage this, if a same input packet will generate multiple output packets, the pipeline manager 61 is operable and configured to issue that same input packet to the packet iterator 63 multiple times. This is tracked using iterator state 62, as will be explained further below. The iterator state 62 thus stores, for each pipeline stage, how far through the iteration for a particular packet the packet iterator 63 has progressed. This is shown in FIG. 12.

In particular, as shown in FIG. 12, it is tracked, for each pipeline stage that has been configured, the number of iterations that should be performed for each input packet (i.e. the number of output packets that are to be generated from that input packet), and it is also tracked, for the most recent packet that has been issued to the packet iterator 63 in respect of each pipeline stage, an indication of the current iteration, i.e. so that the iterator state 62 identifies how many iterations of the packet should be performed and how many have been done so far.

Thus, if the packet is a new packet (step 1007—yes), the iterator state 62 for the associated pipeline stage should be cleared (step 1008) (as this will be the first iteration of that packet), and the packet should then be output to the packet iterator 63 (step 1009). The packet iterator 63 will then process the packet, as will be discussed further below. So long as the iteration is successful (step 1010—yes), the packet header is then written to the respective packet queue/partition for the next pipeline stage (step 1011). The iterator state 62 is then updated to indicate that an iteration has been performed (step 1012). If this is the last iteration of the packet, i.e. such that the number of iterations performed is equal to the number of iterations that should be performed for the pipeline stage in question (step 1013—yes), the packet can then be removed from the respective packet queue/partition for the current pipeline stage (as its processing is now complete) (step 1014), and the pipeline manager 61 can then select a next packet for processing, which may be a packet from any packet queue/partition (i.e. in step 1002). On the other hand, if this is not the last iteration of the packet (step 1013—no), the packet should remain in the respective packet queue/partition for the current pipeline stage so that the packet will remain valid data that can accordingly be selected again by the pipeline manager 61 in step 1002 for its next iteration.

Correspondingly, if the packet is not a new packet (step 1007—no), the iterator state 62 should be fetched from storage (step 1015) before the packet is output to the packet iterator 63 so that if the iteration is successful (i.e. step 1010), the iterator state 62 can be updated accordingly (i.e. in step 1012).

If the iteration is not successful for any reason (step 1010—no), the operation finishes and the packet remains in the respective packet queue/partition for the current pipeline stage so that the pipeline manager 61 will subsequently select it again to re-try the iteration (i.e. the packet will remain valid data that can accordingly be selected again by the pipeline manager 61 in step 1002).

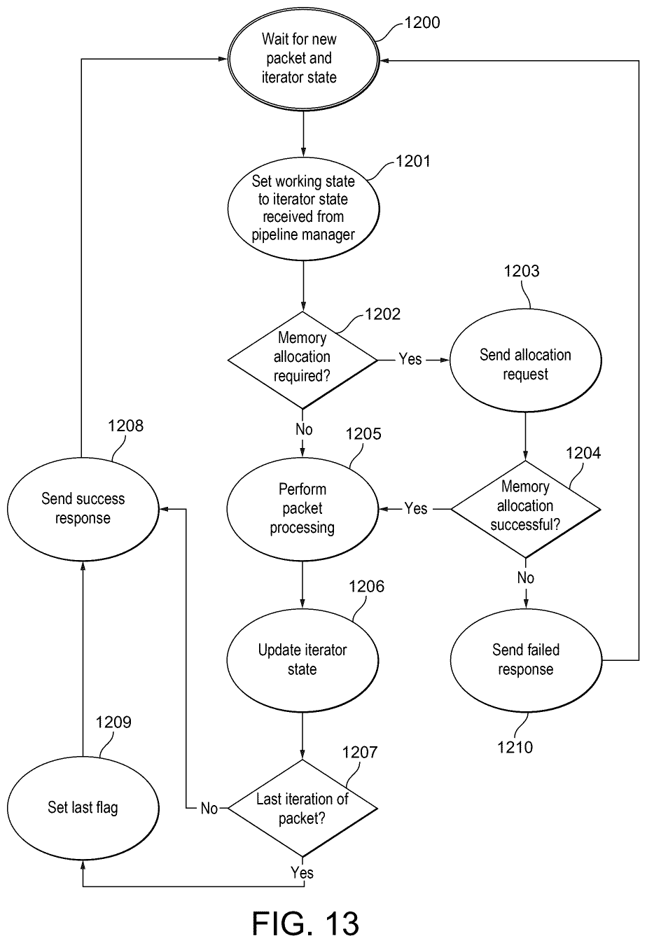

FIG. 13 illustrates the corresponding operation of the packet iterator 63 in response to receiving a packet from the pipeline manager 61 (i.e. in step 1009). Thus, the packet iterator 63 will wait to receive a new packet for processing (step 1200). The pipeline manager 61 when outputting a packet to the packet iterator 63 in embodiments will also provide the iterator state 62, as appropriate. The packet iterator 63 will thus set its working state based on the iterator state 62 received from the pipeline manager 61 (step 1201).

The packet iterator 63 then performs the desired processing for the packet. In particular, if a memory allocation is required for storing an output packet that will be produced (step 1202—yes), the packet iterator 63 will trigger, via the memory manager 70, an appropriate memory allocation request (step 1203). So long as the memory allocation request is successful (step 1204—yes), the packet iterator 63 will then perform the desired packet processing (step 1205), which in the present embodiments will include creating a header for the output packet, and may further include triggering any required compute shading, via the shading manager 47, writing any output data to the allocated memory, issuing any memory deallocation requests, etc., depending on the processing to be performed for the particular pipeline stage that is being executed. Once the packet processing is finished (step 1205), the packet iterator 63 updates its working state to indicate the iteration has completed (step 1206). This can then be signalled back to the pipeline manager 61 as part of the success response (step 1208) to allow the pipeline manager 61 to update the iterator state 62 (i.e. in step 1012).

The packet iterator 63 is also operable to determine whether this is the last iteration of the packet. If so (step 1207—yes), the packet iterator 63 sets an appropriate flag (step 1209) to indicate this. Again, this can be signalled back to the pipeline manager 61 as part of the success response (step 1208) to trigger the operations discussed above, i.e. in step 1013 of FIG. 11.

Thus, so long as the memory allocation is successful, the iteration is performed and an iteration success response is signalled to the pipeline manager 61 (step 1208). This then triggers the operations discussed above, i.e. responsive to step 1010 in FIG. 11. On the other hand, if the memory allocation is not successful (step 1204—no), an iteration failed response is sent (step 1210), and the packet will eventually be selected again for processing by the pipeline manager.

It will be appreciated that is the memory allocation for a packet is not successful, e.g. because there is no free memory in the memory pool assigned to that pipeline stage, depending on the arbitration scheme that is used by the pipeline manager 61, the pipeline manager 61 could select that packet again as the next packet, in which case the memory allocation will fail again. To avoid selecting the same packet again in this situation (which could potentially result in deadlocks if not managed appropriately), a respective flag is used to indicate this (‘malloc_fail’), which flag can be stored in associated with the packets in the respective packet queues/partitions. Thus, if the memory allocation fails, the flag is set accordingly to indicate this, and this then prevents the pipeline manager 61 from selecting that packet for processing. The pipeline manager 61 will accordingly select another item, which should ensure continued progress can be made.

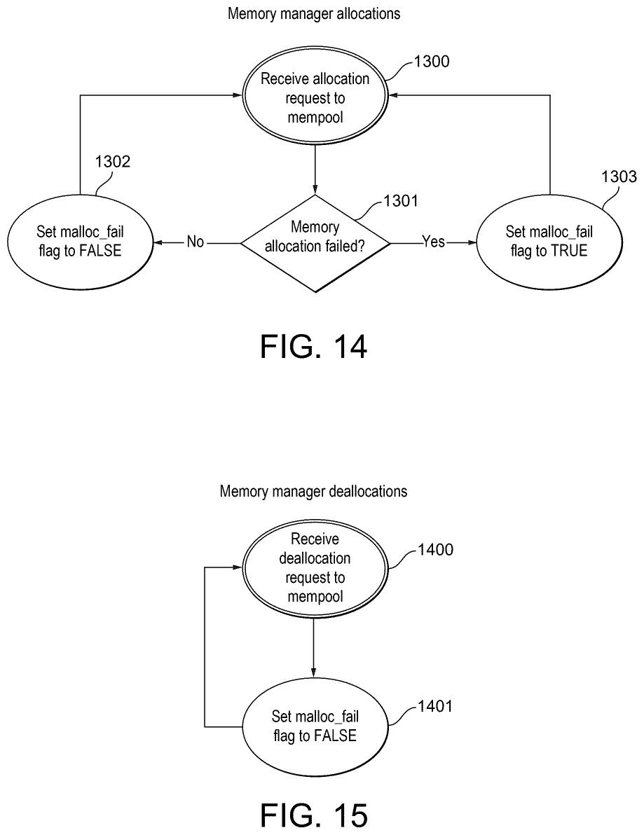

FIG. 14 shows the operation of the memory manager 70 in this regard. Thus, when the memory manager 70 receives a request from the packet iterator 63 to allocate memory for a packet (i.e. in step 1203 in FIG. 13) (step 1300), the memory manager 70 attempts to allocate a portion of a memory pool for storing the packet. If the memory allocation is successful (step 1301—no), the malloc_fail flag is correspondingly set to FALSE, and the packet processing is performed as discussed above. Whereas, if there is no free memory available for the packet, the memory allocation fails (step 1301—yes), the malloc_fail flag is correspondingly set to TRUE. This will then prevent that packet being issued for processing until the malloc_fail flag is cleared (to FALSE). This can be triggered in response the memory manager 70 receiving a request to deallocate a portion of that memory pool, as shown in FIG. 15. Thus, when the memory manager 70 receives a request to deallocate a portion of a memory pool (step 1400), the malloc_fail flag can then be cleared to FALSE.

For instance, over time, as packets are processed and pass through the stages of the geometry packet pipeline 42, they may be temporarily allocated portions of memory within a respective memory pool or set of memory pools that is available to the geometry packet pipeline 42. When a given packet has been processed, and consumed, its allocated portion of memory can therefore be deallocated. Thus, at least some of the pipeline stages within the geometry packet pipeline 42, and particularly the last pipeline stage, is operable to trigger such memory deallocations, which are again handled by the memory manager 70.

Thus, in the present embodiments, rather than having separate pipeline stage circuits for implementing each logical pipeline stage, some of which may not be used if certain pipeline stages are not enabled for a given processing job, all of the logical pipeline stages subsequent to the input packetizer 43 can be (and are) executed using the shared processing circuitry within the packet shading pipeline 60. This can therefore provide a more efficient use of the available processing circuits, and/or reduce silicon area. Further, this should not have significant impact on throughput. For instance, even though can only process one packet at a time (for any of the pipeline stages), in typical use cases, this is not rate-limiting.

The effect and benefit of all this is therefore that the shared processing circuitry within the packet shading pipeline 60 can support and implement any suitable and desired number of logical pipeline stages. This then allows for increased configurability of the geometry packet pipeline 42, for example, as pipeline stages can be flexibly added/removed over time and this can be supported using the same underlying processing circuits.

Various arrangements would be possible in this regard. For example, an effect and benefit of the approach described above is that the application programmer has increased flexibility as to the how the processing pipeline is configured, and which data is passed between different pipeline stages. Thus, whilst various embodiments are described above in relation to certain geometry processing flows, it will be appreciated that the processing pipeline that is executed may generally comprise any suitable and desired processing pipeline, with any desired processing being performed to produce a desired output, and the logical sequence of pipeline stages may, for example, comprise an essentially arbitrary sequence of (compute) shader stages to produce the output.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A graphics processor operable to execute a processing pipeline comprising a sequence of pipeline stages, the graphics processor comprising:
one or more processing circuits to execute the sequence of pipeline stages, the one or more processing circuits including:
an iterator circuit to process sets of work;
a set of work queues, wherein respective work queues within the set of work queues correspond to and identify respective sets of work to be processed for different, respective pipeline stages within the sequence of pipeline stages to be executed as part of the processing pipeline; and
a pipeline manager, the pipeline manager operable to provide respective sets of work from the work queues to the iterator circuit for processing,
wherein the pipeline manager is operable to provide the iterator circuit with sets of work from each and any of the work queues within the set of work queues, and
wherein when a respective set of work to be processed for a particular pipeline stage is provided to the iterator circuit for processing, the iterator circuit is caused to control processing of the set of work according to a respective processing operation to be performed for that particular pipeline stage.

2. The graphics processor of claim 1, wherein there is stored for a particular instance of processing pipeline execution, a set of pipeline configuration information defining the number and type of pipeline stages to be executed as part of the processing pipeline, and wherein the iterator circuit uses the stored pipeline configuration information to control processing of sets of work to execute the pipeline stages within the sequence of pipeline stages to be executed as part of the processing pipeline.

3. The graphics processor of claim 2, wherein the graphics processor includes one or more programmable execution units, and wherein the iterator circuit when processing a respective set of work for a particular pipeline stage is operable to trigger the one or more programmable execution units to execute a corresponding shader program that is to be executed for that particular pipeline stage,
the set of pipeline configuration information identifying the corresponding shader programs to be executed for the pipeline stages within the sequence of pipeline stages to be executed as part of the processing pipeline.

4. The graphics processor of claim 2, wherein state update commands to update the set of pipeline configuration information are propagated through the processing pipeline, and wherein the set of work queues is also operable to store state update commands, the pipeline manager thereby being operable when selecting a next item to be processed from the set of work queues to select a state update command, and to process the state update command to update some or all of the set of pipeline configuration information.

5. The graphics processor of claim 1, wherein the iterator circuit is operable and configured to produce one output packet per processing cycle, and wherein when a pipeline stage within the sequence of pipeline stages to be executed as part of the processing pipeline is to produce a plurality of output packets from a single incoming set of work:
the pipeline manager is operable and configured to provide the same set of work to the iterator circuit for processing a corresponding plurality of times to produce the plurality of output packets.

6. The graphics processor of claim 5, wherein an incoming set of work to be processed by a particular pipeline stage will remain in the respective work queue for that pipeline stage until the set of work has been processed enough times to produce all of the output packets that are to be produced from that same set of work, and wherein the pipeline manager is operable and configured to track how many times a same, single set of work has been processed by the iterator circuit in respect of a particular pipeline stage.

7. The graphics processor of claim 1, wherein the iterator circuit when executing a particular pipeline stage to process a set of work is operable to allocate a portion of memory for storing a corresponding output packet that will be produced from the set of work, and wherein when the memory allocation fails, the set of work remains in the respective work queue for the particular pipeline stage being executed so that the pipeline manager can subsequently re-select that set of work for processing.

8. The graphics processor of claim 7, wherein in response to a memory allocation for a set of work failing, a respective indicator associated with the set of work is set accordingly to indicate that the memory allocation has failed, and the pipeline manager is then controlled to not re-select that set of work for processing until the indicator has been reset to indicate that the processing of that set of work should be re-tried.

9. The graphics processor of claim 1, wherein the set of work queues comprise respective partitions of a shared work buffer.

10. The graphics processor of claim 9, wherein the number of pipeline stages is configurable in use, and wherein the shared work buffer is partitioned into the set of work queues based on the number of pipeline stages configured for the current instance of processing pipeline execution.

11. A method of operating a graphics processor to execute a processing pipeline comprising a logical sequence of pipeline stages, the graphics processor comprising:
one or more processing circuits to execute the logical sequence of pipeline stages, the one or more processing circuits including:
an iterator circuit;
a set of work queues, wherein respective work queues within the set of work queues correspond to and identify respective sets of work to be processed for different, respective pipeline stages within the logical sequence of pipeline stages to be executed as part of the processing pipeline; and
a pipeline manager, the pipeline manager operable to provide respective sets of work from the work queues to the iterator circuit for processing,
wherein the pipeline manager is operable to provide the iterator circuit with sets of work from any of the work queues within the set of work queues, and
the method comprising:
the pipeline manager providing a set of work from the respective work queue corresponding to a particular pipeline stage to the iterator circuit for processing; and
the iterator circuit controlling processing of the set of work according to a respective processing operation to be performed for that particular pipeline stage.

12. The method of claim 11, comprising:
storing, for a particular instance of processing pipeline execution, a set of pipeline configuration information defining the number and type of pipeline stages to be executed as part of the processing pipeline; and
the iterator circuit using the stored pipeline configuration information to control processing of sets of work to execute the pipeline stages within the sequence of pipeline stages to be executed as part of the processing pipeline.

13. The method of claim 12, wherein the graphics processor includes one or more programmable execution units, and wherein the iterator circuit when processing a respective set of work for a particular pipeline stage is operable to trigger the one or more programmable execution units to execute a corresponding shader program that is to be executed for that particular pipeline stage,
the set of pipeline configuration information identifying the corresponding shader programs to be executed for the pipeline stages within the sequence of pipeline stages to be executed as part of the processing pipeline.

14. The method of claim 12, comprising propagating one or more state update commands to update the set of pipeline configuration information through the processing pipeline, wherein the state update commands are stored in the set of work queues, and wherein the pipeline manager when selecting a next item to be processed from the set of work queues, when selecting a state update command will process the state update command to update some or all of the set of pipeline configuration information.

15. The method of claim 11, wherein the iterator circuit is operable and configured to produce one output packet per processing cycle, and wherein when a pipeline stage within the sequence of pipeline stages to be executed as part of the processing pipeline is to produce a plurality of output packets from a single incoming set of work, the method comprises the pipeline manager:
tracking how many times a same, single set of work has been processed by the iterator circuit in respect of a particular pipeline stage; and
providing the same set of work to the iterator circuit for processing a corresponding plurality of times to produce the plurality of output packets that are to be produced from that same set of work before removing the set of work from the respective work queue for the current pipeline stage.

16. The method of claim 11, comprising:
the iterator circuit when executing a particular pipeline stage to process a set of work:
allocating a portion of memory for storing a corresponding output packet that will be produced from the set of work, and
wherein when the memory allocation fails:
the method comprises:
keeping the set of work remains in the respective work queue for the particular pipeline stage being executed; and
the pipeline manager subsequently re-selecting that same set of work for processing.

17. The method of claim 16, wherein in response to a memory allocation for a set of work failing, the method comprises:
setting a respective indicator associated with the set of work accordingly to indicate that the memory allocation has failed, and
controlling the pipeline manager to not re-select that set of work for processing until the indicator has been reset to indicate that the processing of that set of work should be re-tried.

18. The method of claim 11, wherein the set of work queues comprise respective partitions of a shared work buffer.

19. The method of claim 18, wherein the number of pipeline stages is configurable in use, and wherein the shared work buffer is partitioned into the set of work queues based on the number of pipeline stages configured for the current instance of processing pipeline execution.

20. A non-transitory computer readable medium storing instructions that when executed by one or more processor will cause the one or more processor to perform a method operating a graphics processor to execute a processing pipeline comprising a logical sequence of pipeline stages, the graphics processor comprising:
one or more processing circuits to execute the logical sequence of pipeline stages, the one or more processing circuits including:
an iterator circuit;
a set of work queues, wherein respective work queues within the set of work queues correspond to and identify respective sets of work to be processed for different, respective pipeline stages within the logical sequence of pipeline stages to be executed as part of the processing pipeline; and
a pipeline manager, the pipeline manager operable to provide respective sets of work from the work queues to the iterator circuit for processing,
wherein the pipeline manager is operable to provide the iterator circuit with sets of work from any of the work queues within the set of work queues, and
the method comprising:
the pipeline manager providing a set of work from the respective work queue corresponding to a particular pipeline stage to the iterator circuit for processing; and
the iterator circuit controlling processing of the set of work according to a respective processing operation to be performed for that particular pipeline stage.
